(19) United States
(12) Patent Application Publication
(10) Pub. No.: US 2012/0016814 A1
(43) Pub. Date: Jan. 19, 2012

(54) PRODUCTION OF MINIMALLY PROCESSED FOODS

(75) Inventor: WILLIAM EARL EVANS, Wellman, IA (US)

(73) Assignee: OPEN GATES BUSINESS DEVELOPMENT CORPORATION, Kalona, IA (US)

(21) Appl. No.: 13/031,499

(22) Filed: Feb. 21, 2011

Related U.S. Application Data
(60) Provisional application No. 61/399,743, filed on Jul. 16, 2010.

(51) Int. Cl. G06Q 90/00; A23C 9/00; A23C 3/02

(52) U.S. Cl. 705/500; 426/522; 426/580

(57) ABSTRACT

A system, method, and apparatus for a non-industrialized, sustainable, minimally processed organic dairy industry that provides the highest quality milk and milk derivative products that is end-to-end from ground-to-cow-to-dairy-to-distribution-to-consumer, and centered on low temperature batch or vat pasteurization in which the product is minimally processed, for which product certificates, which include a numerical score and/or a corresponding color code that rank organic, minimally processed products as the high quality. The product certificates can also be applied to non-milk products, such as, but not limited to, meats, fowl, fish, vegetables, nuts, fruits, eggs, etc.

### CROSS-REFERENCE TO RELATED APPLICATIONS

This application claims priority to U.S. Provisional Application Ser. No. 61/399,743 filed Jul. 16, 2010 which is entitled SYSTEM, METHOD, AND APPARATUS FOR HIGH QUALITY DAIRY PRODUCTS which is herein incorporated by reference.

### FIELD OF THE INVENTION

The present invention relates to a system, method, and apparatus for providing the highest quality dairy products, which are minimally processed. The present invention also includes a scoring system, which can also be used to score all dairy and non-dairy agricultural products against the standard in which minimally processed foods are rated as the highest quality.

### BACKGROUND OF THE INVENTION

We live in an age of Industrialized Agriculture. Industrial Agriculture is a form of modern farming that refers to the industrialized production of livestock, poultry, fish, and crops. The methods of industrial agriculture are techno-scientific, economic, and political. They include innovation in agricultural machinery and farming methods, genetic technology, techniques for achieving economies of scale in production, the creation of new markets for consumption, the application of patent protection to genetic information, and global trade. These methods are widespread in developed nations and increasingly prevalent worldwide. Most of the meat, dairy, eggs, fruits, and vegetables available in supermarkets are produced using these methods of industrial agriculture.

What is needed is a system, method, and apparatus for a non-industrialized, sustainable, minimally processed organic dairy industry that provides the highest quality milk and milk derivative products that is end-to-end from ground-to-cow-to-dairy-to-distribution-to-consumer, and is centered on low temperature pasteurization in which the product is minimally processed, for which product certificates, which include a numerical score and/or a corresponding color code. Furthermore, the aforementioned product certificates can also be applied to non-milk products, such as, but not limited to, meats, fowl, fish, vegetables, nuts, fruits, eggs, etc.

### SUMMARY OF THE INVENTION

Therefore, it is a primary object, feature or advantage of the present invention to improve over the state of the art.

It is an object, feature or advantage of the present invention to provide a system, method, and apparatus to solve the problem of low quality milk and milk derivative products produced by industrial agriculture.

It is an object, feature or advantage of the present invention to provide a system, method, and apparatus to provide end-to-end quality for the highest quality milk and milk derivative products from a ground-to-cow-to-dairy-to-distribution-to-consumer system.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature pasteurization.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using quality control/quality assurance/standards to control the quality of water sources used on dairy farms that provide milk for use in the present invention.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using quality control/quality assurance/standards to control the quality of dairies that pasteurize and containerize milk that is to be transported, distributed, and sold.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using quality control/quality assurance/standards to control, collect, and annotate location and time stamps related to cows for feeding, milking, etc, on farms that supply milk for use in the present invention; transport vehicles; and distribution network outlets.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using quality control/quality assurance/standards to control the quality of farms that produce milk for use in the present invention through a knowledge of dairy land ownership and history, and knowledge of a farmer's history, resume, credentials, training, etc.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using quality control/quality assurance/standards to monitor the quality of transportation companies that transport milk and milk derivative products produced by the present invention.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using quality control/quality assurance/standards to monitor the quality of distribution companies and outlets that transport milk and milk derivative products produced by the present invention.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using XML technology to create an interactive communication, data, and business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using Cascading Style Sheet (CSS) technology to create an interactive communication, data, and business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using barcode (machine readable) technology to create an interactive communication, data, business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using radio frequency identification (RFID) technology to create an interactive communication, data, and business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using radio frequency identification (RFID) technology based on EPCglobal Gen 2 standards to create an interactive communication, data, business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using hash technology to create a secure, interactive communication, data, and business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using sensor technology to create an interactive data gathering and monitoring system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using SMS technology to create an interactive communication, data gathering and monitoring, business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using SMS technology in conjunction with RFID technology to create an interactive communication, data gathering and monitoring, business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using SMS technology in conjunction with barcode technology (machine readable) to create an interactive communication, data gathering and monitoring, business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization using SMS technology in conjunction with barcode technology (machine readable) to create an interactive communication, data gathering and monitoring, business system for non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output certifications for the non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output instant certifications for the non-industrialized, sustainable, minimally processed minimally processed organic dairy industry.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output instant certifications for the non-industrialized, sustainable, minimally processed minimally processed organic dairy industry that include an overall numerical grade, and a corresponding color code.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output instant certifications for the non-industrialized, sustainable, minimally processed minimally processed organic dairy industry that include a total carbon footprint for milk produced by the present invention.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output instant certifications for the non-industrialized, sustainable, minimally processed minimally processed organic dairy industry that include an estimate of the overall “greenness” of the milk produced by the present invention.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output instant certifications for the non-industrialized, sustainable, minimally processed minimally processed organic dairy industry that include an estimate of the overall “greenness” of the milk produced by the present invention that includes the original farmer, the dairy, the transportation company, and the distribution network and outlets.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output instant certifications for the non-industrialized, sustainable, minimally processed minimally processed organic dairy industry that include a statement concerning an micro-economics or micro-finance used by the milk producers and distributors in the farm-to-market chain of the present invention.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output instant certifications for the non-industrialized, sustainable, minimally processed minimally processed organic dairy industry that include a statement concerning an micro-economics or micro-finance sponsored by the milk producers and distributors in the farm-to-market chain of the present invention.

It is an object, feature or advantage of the present invention to provide a system, method, and apparatus to provide end-to-end quality for the highest quality milk and milk derivative products from a ground-to-cow-to-dairy-to-distribution-to-consumer system, centered on low temperature batch or vat pasteurization to output instant certifications for the non-industrialized, sustainable, minimally processed minimally processed organic dairy industry that include a statement concerning any fair trade network used or sponsored by the milk producers and distributors in the farm-to-market chain of the present invention.

It is an object, feature or advantage of the present invention to provide a system, method, and apparatus to solve the problem of low quality agricultural products, such as, but not limited to, meats, fowl, fish, vegetables, nuts, fruits, and eggs etc., produced by industrial agriculture.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-to-distribution-to-consumer system.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., from a ground-to-distribution-to-consumer system using quality control/quality assurance/standards to control the quality of water sources used on farms that provide agricultural products, such as, but not limited to, meats, fowl, fish, vegetables, nuts, fruits, eggs etc.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using quality control/quality assurance/standards to control the quality of processing facilities.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using quality control/quality assurance/standards to control, collect, and annotate location and time stamps related to agricultural products, such as, but not limited to, meats, fowl, fish, vegetables, nuts, fruits, eggs, etc., on farms.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using quality control/quality assurance/standards to control the quality of farms that produce agricultural product through a knowledge of dairy land ownership and history, and knowledge of a farmer's history, resume, credentials, training, etc.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using quality control/quality assurance/standards to monitor the quality of transportation companies that transport agricultural products, such as, but not limited to, meats, fowl, fish, vegetables, nuts, fruits, eggs etc.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using quality control/quality assurance/standards to monitor the quality of distribution companies and outlets that transport and sell agricultural products, such as, but not limited to, meats, fowl, fish, vegetables, nuts, fruits, eggs etc.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using XML technology to create an interactive communication, data, and business system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using Cascading Style Sheet (CSS) technology to create an interactive communication, data, and business system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using barcode (machine readable) technology to create an interactive communication, data, business system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using radio frequency identification (RFID) technology to create an interactive communication, data, and business system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using radio frequency identification (RFID) technology based on EPCglobal Gen 2 standards to create an interactive communication, data, business system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using hash technology to create a secure, interactive communication, data, business system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using sensor technology to create an interactive data gathering and monitoring system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using SMS technology to create an interactive communication, data gathering and monitoring, business system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using SMS technology in conjunction with RFID technology to create an interactive communication, data gathering and monitoring, business system for non-industrialized, sustainable, minimally processed minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using SMS technology in conjunction with barcode technology (machine readable) to create an interactive communication, data gathering and monitoring, business system for non-industrialized, sustainable, minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system using SMS technology in conjunction with barcode technology (machine readable) to create an interactive communication, data gathering and monitoring, business system for non-industrialized, sustainable, minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output certifications for the non-industrialized, sustainable, minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output instant certifications for the non-industrialized, sustainable, minimally processed organic agricultural industry.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output instant certifications for the non-industrialized, sustainable, minimally processed organic dairy industry that include an overall numerical grade, and a corresponding color code.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output instant certifications for the non-industrialized, sustainable, minimally processed organic dairy industry that include a total carbon footprint for agricultural products, such as, but not limited to, meats, fowl, fish, vegetables, nuts, fruits, eggs etc.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output instant certifications for the non-industrialized, sustainable, minimally processed organic dairy industry that include an estimate of the overall “greenness” of agricultural product.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output instant certifications for the non-industrialized, sustainable, minimally processed organic agricultural industry that include an estimate of the overall “greenness” of agricultural product that includes the original farmer, the processing facility, the transportation company, and the distribution network and outlets.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output instant certifications for the non-industrialized, sustainable, minimally processed organic agricultural industry that include a statement concerning an micro-economics or micro-finance used by the agricultural producers and distributors in the farm-to-market chain of the present invention.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output instant certifications for the non-industrialized, sustainable, minimally processed organic agricultural industry that includes a statement concerning an micro-economics or micro-finance sponsored by the agricultural producers and distributors in the farm-to-market chain of the present invention.

It is an object, feature or advantage of the present invention to provide a system, method, and apparatus to provide end-to-end quality for the highest quality agricultural products, such as, but not limited to, meats, fowl, fish, vegetables, nuts, fruits, eggs etc., in a ground-to-distribution-to-consumer system to output instant certifications for the non-industrialized, sustainable, minimally processed organic agricultural industry that includes a statement concerning any fair trade network used or sponsored by the agricultural producers and distributors in the farm-to-market chain of the present invention.

No single embodiment of the present invention need meet any and all of these objects, features and advantages.

### SUMMARY OF THE INVENTION

The present invention is a system, method, and apparatus for a non-industrialized, sustainable, minimally processed organic dairy industry that provides the highest quality milk and milk derivative products that is end-to-end from ground-to-cow-to-dairy-to-distribution-to-consumer, and is centered on low temperature pasteurization in which the product is minimally processed, for which product certificates, which include a numerical score and/or a corresponding color code, which can also be applied to non-milk products, such as, but not limited to, meats, fowl, fish, vegetables, nuts, fruits, eggs, etc.

The present invention for a non-industrialized, sustainable, minimally processed organic dairy industry end-to-end from ground-to-cow-to-dairy-to-distribution-to-consumer, and is centered on low temperature pasteurization that uses technology responsibly for quality assurance, quality control, in accordance with standards, and is capable of outputting certifications with grades and statements concerning total carbon footprint; total “greenness”, micro-economics or micro-finance used or supported; and fair trade that may have been used in the production, transportation, storage, and sale of the milk or milk-derivative product produced in accordance with the present invention.

The present invention practices the vat, or batch, pasteurization aspect of the present invention, in conjunction with milk produced on Amish and Mennonite farms that are pure in their historical context of non-industrialized, sustainable, minimally processed organic farming methods that have been practiced continuously for over 100 years, in order to produce that highest quality milk and milk derivative products available in the marketplace today. In addition, other small organic farm producers are capable of producing very high quality milk and milk derivative products that are available in the marketplace today.

The present invention's numerical and corresponding color coded scoring system can also be applied to all non-dairy agricultural products, including, but not limited to, meats, fowl, fish, vegetables, processed food, fruits, eggs, etc.

### BRIEF DESCRIPTION OF THE DRAWINGS

The present invention will become more fully understood from the detailed description and the accompanying drawings, wherein:

FIG. 1 is a block diagram of all the quality, technology, dairy farm, dairy, transportation, and distribution network components that can be used in conjunction with the present invention to create certified output statements and documents.

FIG. 2 is a block diagram of the quality, technology, dairy farm, dairy, transportation, and distribution network components that were selected for use in a minimal state of compliance in accordance with the present invention.

FIG. 3 is a block diagram of the quality, technology, dairy farm, dairy, transportation, and distribution network components that were selected for use in a maximal state of compliance in accordance with the present invention.

FIG. 4 is a block diagram of all the quality, technology, non-dairy farm, processing plant, transportation, and distribution network components that can be used in conjunction with the present invention to create certified output statements and documents.

FIG. 5 is a block diagram of the quality, technology, non-dairy farm, processing plant, transportation, and distribution network components that were selected for use in a minimal state of compliance in accordance with the present invention.

FIG. 6 is a block diagram of the quality, technology, non-dairy farm, processing plant, transportation, and distribution network components that were selected for use in a maximal state of compliance in accordance with the present invention.

FIG. 7 is an illustration of the present invention's scoring system shown on a cell phone display.

FIG. 8 is an illustration of the present invention's scoring system shown on a cell phone display.

### DESCRIPTION OF VARIOUS EMBODIMENTS

Definitions—The following definitions are used throughout the present invention:
Minimally Processed—The present invention is centered on producing the highest quality products, and rating the highest quality products as part of the philosophy of doing less—not more—when it comes to food, produces the highest quality food possible. Not only in a dairy, or food processing plant, but on the farm where the food products originate. As an example, the present invention's organic milk has a cream top on it. It's not something you might expect to find when you open a bottle of milk, but it's the way nature intended milk to be. As another example, the present inventions yogurt has a completely different texture than almost any yogurt on the market, all because the practitioners of the present invention let the yogurt remain as natural as possible. They don't add stabilizers or thickeners that customers have come to expect as normal. Minimally processed products are healthy, simple, and distinct. The following discussion further illustrates the benefits of minimally processed organic food sources, which have been minimally processed in dairies, or food processing plants, which is how the practitioners of the present invention oversee, purchase, process, and distribute their food products. Furthermore, in an effort to educate consumers, the practitioners of the present invention have created a scoring and reporting system that can be used by consumers to make intelligent choices in their food investments:

“In today's world of nutritional confusion, many of us believe that saturated fats must be completely avoided in order to prevent disease. If we would take a look at ourselves on a microscopic level, however, we would see a completely different picture: approximately half of each of the tiny membranes surrounding your individual cells is made of saturated fat!

Saturated fat is so important to good health that if our bodies are deprived of it in the diet, they will start to manufacture it from carbohydrates. It is still better, though, to obtain saturated fat from whole food sources such as coconut, dairy, grass-fed meat, and egg yolks. Requiring your body to make saturated fat from carbohydrates requires the release of insulin to digest the carbohydrates, while fat digestion does not. Over time, excess insulin release may lead to premature aging, weight gain, and blood sugar problems such as hypoglycemia or diabetes.

An average glass of whole milk contains about 8 grams of fat, with slightly over half of that fat as saturated fat (USDA Food Composition Database). The term “saturated” refers to the arrangement of carbon and hydrogen in the structure of the fat—a saturated fat is “saturated” with hydrogen because it has a hydrogen molecule at every available location. Saturated fat is an important building block for brain tissue—especially in children—and it also serves as an important ingredient for making hormones. A recent study found that women who choose low-fat dairy products over full-fat dairy products are more likely to experience anovulatory infertility (J. E. Chavarro et al., “A Prospective Study of Dairy Foods Intake and Anovulatory Infertility.” Human Reproduction 2007; 22(5):1340-7), which is an inability to become pregnant due to lack of ovulation.

Dairy fat in particular contains two types of saturated fat with amazing health benefits: butyrate and CLA. Butyrate, a specific type of saturated fat found in dairy, serves as the primary food for colon cells (E. Hijova et al., “Short Chain Fatty Acids and Colonic Health.” Bratisl Lek Listy 2007; 108(8):354-8). This fat is made through a fermentation process by the healthy bacteria in the gut. This fat can also be found in abundance in butter and whole milk yogurt. Butyrate has been shown to play a preventive role in formation of colon cancer (J. M. Wong et al., “Colonic Health: Fermentation and Short Chain Fatty Acids.” Journal of Clinical Gastroenterology 2006; 40(3):235-43). CLA (conjugated linoleic acid) is another important saturated fat found in dairy fat, with approximately five times more CLA in the milk of cows that are fed grass (their natural food) as opposed to grain. CLA is currently the focus of much research for its anti-cancer properties. In fact, a 2005 Swedish study found that “high intakes of high-fat dairy foods and CLA may reduce the risk of colorectal cancer” (S. C. Larsson et al., “High-fat Dairy Food and Conjugated Linoleic Acid Intakes in Relation to Colorectal Cancer Incidence in the Swedish Mammography Cohort.” American Journal of Clinical Nutrition 2005; 82(4):894-900). CLA also encourages the body to use calories to build muscle instead of storing them as fat which is especially important in children who are developing rapidly. (B. A. Corl et al., “Conjugated Linoleic Acid Reduces Body Fat Accretion and Lipogenic Gene Expression in Neonatal Pigs Fed Low- or High-Fat Formulas.” Journal of Nutrition 2008; 138(3):449-54) (C. S. Berkey et al., “Milk, Dairy Fat, Dietary Calcium, and Weight Gain: A Longitudinal Study of Adolescents.” Archives of Pediatric Adolescent Medicine 2005; 159(6):543-50.“)

With all of this said, it is important to remember that pesticides, artificial hormones, and other harmful substances tend to lodge in the fat portion of a food. So, as you begin to increase the dairy fat content of your diet please be mindful of the source of your food and choose milk from healthy, chemical-free cows.

Here's another example of the concept of minimally processed as applied to eggs: Cage-Free Birds are fed a vegetarian diet, free of hormones. These birds are housed in open barns where they have room to move about and engage in natural hen behavior. They have 1.25 to 1.5 sq. ft. per bird of floor space. Free-Range Birds are fed a vegetarian diet, free of hormones. The birds are housed in open barns like Cage Free Birds with the addition of 2 sq. ft. per bird of access to the outdoors. (Note: all organic eggs are required to be free range.) The birds eat a diet made up mostly of corn and soybeans. Vegetarian just means that the feed is free of any animal byproducts.

Amish—The present inventions milk and milk derivative products come largely from small, Amish/Mennonite family farms where the average daily herd is 30 cows and where most of the work is still done by hand. Many of these farms—most of which are on about 80 tillable acres—have been in the same family for 150 years and have never been touched by chemical herbicides or pesticides. These cows are grass fed. Over the past few decades many studies have revealed that pasture-feeding is much healthier for the cows and for the consumer.

“Greener Pastures: How Grass-fed Beef and Milk Contribute to Health Eating by Kate Clancy is the first study to synthesize the findings of virtually every English-language study (25 were chosen for analysis) comparing the amounts of total fats, saturated fats, omega-3 fatty acids, and Conjugated Linoleic Acid (CLA) in both pasture-raised and conventionally raised beef and dairy cattle. The report also combined analyses of the nutrition, environmental, and public health benefits of grass-based farming techniques.

The report found that grass-fed milk contains higher levels of omega-3 fatty acids, the so-called beneficial fats. Grass-fed milk tends to be higher in an omega-3 fatty acid called alpha-linolenic acid (ALA) that scientists have demonstrated reduces the risk of heart disease. And grass-fed milk also is higher in CLA, a fatty acid shown in animal studies to protect against cancer. CLA was discovered in 1978 by Michael W. Pariza at the University of Wisconsin while looking for mutagen formations in meat during cooking. The most abundant source of natural CLA is the meat and dairy products of grass-fed animals. Research conducted since 1999 shows that grazing animals have from 3 to 5 times more CLA than animals fattened on grain in a feedlot. Simply switching from grain-fed to grass-fed products can greatly increase your intake of CLA”.

Mennonite—The present inventions milk and milk derivative products come largely from small, Amish/Mennonite family farms where the average daily herd is 30 cows and where most of the work is still done by hand. Many of these farms—most of which are on about 80 tillable acres—have been in the same family for 150 years and have never been touched by chemical herbicides or pesticides. These cows are grass fed. Over the past few decades many studies have revealed that pasture-feeding is much healthier for the cows and for the consumer.

“Greener Pastures: How Grass-fed Beef and Milk Contribute to Health Eating by Kate Clancy is the first study to synthesize the findings of virtually every English-language study (25 were chosen for analysis) comparing the amounts of total fats, saturated fats, omega-3 fatty acids, and Conjugated Linoleic Acid (CLA) in both pasture-raised and conventionally raised beef and dairy cattle. The report also combined analyses of the nutrition, environmental, and public health benefits of grass-based farming techniques.

The report found that grass-fed milk contains higher levels of omega-3 fatty acids, the so-called beneficial fats. Grass-fed milk tends to be higher in an omega-3 fatty acid called alpha-linolenic acid (ALA) that scientists have demonstrated reduces the risk of heart disease. And grass-fed milk also is higher in CLA, a fatty acid shown in animal studies to protect against cancer. CLA was discovered in 1978 by Michael W. Pariza at the University of Wisconsin while looking for mutagen formations in meat during cooking. The most abundant source of natural CLA is the meat and dairy products of grass-fed animals. Research conducted since 1999 shows that grazing animals have from 3 to 5 times more CLA than animals fattened on grain in a feedlot. Simply switching from grain-fed to grass-fed products can greatly increase your intake of CLA.

Organic—Organic foods are minimally processed by definition.

Organic foods are made in a way that complies with organic standards set by national governments and international organizations. In the United States, organic production is a system that is managed in accordance with the Organic Foods Production Act (OFPA) of 1990 and regulations in Title 7, Part 205 of the Code of Federal Regulations to respond to site-specific conditions by integrating cultural, biological, and mechanical practices that foster cycling of resources, promote ecological balance, and conserve biodiversity (Labeling: Preamble). For the vast majority of human history, agriculture can be described as organic; only during the 20th century was a large supply of new synthetic chemicals introduced to the food supply. This more recent style of production is referred to as “conventional.” Under organic production, the use of conventional non-organic pesticide (including insecticides, fungicides, and herbicides) is precluded. However, contrary to popular belief, certain sprays and other materials that meet organic standards are allowed in the production of organic food (Nestle, Marion. 2006. What to Eat. NY: North Point Press.) If livestock are involved, the livestock must be reared with regular access to pasture and without the routine use of antibiotics or growth hormones (http://www.organicconsumers.org/articles/article_{—}20459.cfm). In most countries, organic produce may not be genetically modified. It has been suggested that the application of nanotechnology to food and agriculture is a further technology that needs to be excluded from certified organic food (Paull, J. & Lyons, K. (2008), Nanotechnology: The Next Challenge for Organics, Journal of Organic Systems, 3(1) 3-22). The Soil Association (UK) has been the first organic certifier to implement a nano-exclusion (Paull, J. & Lyons, K. (2008), Nanotechnology: The Next Challenge for Organics, Journal of Organic Systems, 3(1) 3-22).

Organic food production is a heavily regulated industry, distinct from private gardening. Currently, the European Union, the United States, Canada, Japan and many other countries require producers to obtain special certification in order to market food as “organic” within their borders. Most certifications allow some chemicals and pesticides to be used, so consumers should be aware of the standards for qualifying as “organic” in their respective locales.

Historically, organic farms have been relatively small family-run operations, which is why organic food was once only available in small stores or farmers' markets. However, since the early 1990s organic food production has had growth rates of around 20% a year, far ahead of the rest of the food industry, in both developed and developing nations. As of April 2008, organic food accounts for 1-2% of food sales worldwide.

In 1939, Lord Northbourne coined the term organic farming in his book Look to the Land (1940), out of his conception of “the farm as organism,” to describe a holistic, ecologically-balanced approach to farming—in contrast to what he called chemical farming, which relied on “imported fertility” and “cannot be self-sufficient nor an organic whole.” (John Paull, “The Farm as Organism: The Foundational Idea of Organic Agriculture”, Elementals: Journal of Bio-Dynamics Tasmania, vol. 80 (2006): pp. 14-18). This is different from the scientific use of the term “organic,” to refer to a class of molecules that contain carbon, especially those involved in the chemistry of life.

Processed organic food usually contains only organic ingredients. If non-organic ingredients are present, at least a certain percentage of the food's total plant and animal ingredients must be organic (95% in the United States, (Labeling: Preamble) Canada, and Australia) and any non-organically produced ingredients are subject to various agricultural requirements. Foods claiming to be organic must be free of artificial food additives, and are often processed with fewer artificial methods, materials and conditions, such as chemical ripening, food irradiation, and genetically modified ingredients. Pesticides are allowed so long as they are not synthetic.

Early consumers interested in organic food would look for non-chemically treated, non-use of unapproved pesticides, fresh or minimally processed food. They mostly had to buy directly from growers: “Know your farmer, know your food” was the motto. Personal definitions of what constituted “organic” were developed through firsthand experience: by talking to farmers, seeing farm conditions, and farming activities. Small farms grew vegetables (and raised livestock) using organic farming practices, with or without certification, and the individual consumer monitored. As demand for organic foods continued to increase, high volume sales through mass outlets such as supermarkets rapidly replaced the direct farmer connection. Today there is no limit to organic farm sizes and many large corporate farms currently have an organic division. However, for supermarket consumers, food production is not easily observable, and product labeling, like “certified organic”, is relied on. Government regulations and third-party inspectors are looked to for assurance.

The USDA carries out routine inspections of farms that produce USDA Organic labeled foods (Nestle, Marion. 2006. What to Eat. NY: North Point Press). Of the 30 third party inspectors 15 of them have been placed under probation after an audit. On Apr. 20, 2010, the Department of Agriculture said that it would begin enforcing rules requiring the spot testing of organically grown foods for traces of pesticides, after an auditor exposed major gaps in federal oversight of the organic food industry (http://www.organicconsumers.org/articles/article_{—}20459.cfm).

To be certified organic, products must be grown and manufactured in a manner that adheres to standards set by the country they are sold in:

Australia: Australian Organic Standard and NASAA Organic Standard

Canada: Canada Gazette, Government of Canada

European Union: EU-Eco-regulation
Sweden: KRAV
United Kingdom: Department for Environment, Food and Rural Affairs (DEFRA)

Norway: Debio Organic certification

India: NPOP, (National Program for Organic Production)

Japan: JAS Standards.

United States: National Organic Program (NOP) Standards

Several surveys and studies have attempted to examine and compare conventional and organic systems of farming. The general consensus across these surveys (Stolze, M.; Pion, A.; Häring, A. M. and Dabbert, S. (2000) Environmental impacts of organic farming in Europe. Organic Farming in Europe: Economics and Policy Vol. 6. Universität Hohenheim, Stuttgart-Hohenheim). (Hansen, Birgitt; Alrøe, H. J. & Kristensen, E. S. (January 2001)). “Approaches to assess the environmental impact of organic farming with particular regard to Denmark”. Agriculture, Ecosystems & Environment 83: 11-26. doi:10.1016/50167-8809(00)00257-7 is that organic farming is less damaging for the following reasons:
Organic farms do not consume or release synthetic pesticides into the environment—some of which have the potential to harm soil, water and local terrestrial and aquatic wildlife.
Organic farms are better than conventional farms at sustaining diverse ecosystems, i.e., populations of plants and insects, as well as animals.
When calculated either per unit area or per unit of yield, organic farms use less energy and produce less waste, e.g., waste such as packaging materials for chemicals.

However, some critics of organic farming methods believe that organic farms require more land to produce the same amount of food as conventional farms (see ‘Yield’ section, below). They argue that if this is true, organic farms could potentially destroy the rain forests and wipe out many ecosystems. (a b Bob Goldberg. “The Hypocrisy of Organic Farmers”. AgBioWorld. http://www.agbioworld.org/biotech-info/articles/biotech-art/hypocrisy.html. Retrieved 2007 Oct. 10). (a b Andrew Leonard. “Save the rain forest—boycott organic?”. How The World Works. http://www.salon.com/tech/htww/2006/12/11/borlaug/. Retrieved 2007 Oct. 10).

A 2003 investigation by the Department for Environment Food and Rural Affairs in the UK found, similar to other reports, that organic farming “can produce positive environmental benefits”, but that some of the benefits were decreased or lost when comparisons are made on “the basis of unit production rather than area”. (Department for Environment Food and Rural Affairs. “Assessment of the environmental impacts of organic farming”. http://www.defra.gov.uk/foodfarm/growing/organic/policy/research/pdf/env-impacts2.pdf. Retrieved 2009 Sep. 29).

One study found a 20% smaller yield from organic farms using 50% less fertilizer and 97% less pesticide (Mader, et al.; Fliessbach, A; Dubois, D; Gunst, L; Fried, P; Niggli, U (2002). “Soil Fertility and Biodiversity in Organic Farming”. Science 296 (5573): 1694-1697. doi:10.1126/science.1071148. PMID 12040197. http://www.sciencemag.org/cgi/content/full/296/5573/1694). Studies comparing yields have had mixed results (Welsh, Rick (1999). “Economics of Organic Grain and Soybean Production in the Midwestern United States”. Henry A. Wallace Institute for Alternative Agriculture.). Supporters claim that organically managed soil has a higher quality (Johnston, A. E. (1986). “Soil organic-matter, effects on soils and crops”. Soil Use Management 2: 97-105. doi:10.1111/j.1475-2743.1986.tb00690.x) and higher water retention. This may help increase yields for organic farms in drought years.

One study from the Danish Environmental Protection Agency found that, area-for-area, organic farms of potatoes, sugar beet and seed grass produce as little as half the output of conventional farming. (The Bichel Committee. 1999. Report from the main committee. Danish Environmental Protection Agency. Conclusions and recommendations of the Committee: 8.7.1 Total phase-out. Report not available in print but posted online at: http://www.mst.dk/udgiv/Publications/1998/87-7909-445-7/html/kap08_eng.htm#8.7.1. [Excerpt] “A total abolition of pesticide use would result in an average drop in farming yields of between 10% and 25%, at the farm level; the smallest losses would occur in cattle farming. On farms that have a large proportion of special crops, such as potatoes, sugar beet and seed grass, the production losses in terms of quantity would be closer to 50%. These crops would probably be ousted by other crops.”). Findings like these, and the dependence of organic food on manure from low-yield cattle, has prompted criticism from scientists that organic farming is environmentally unsound and incapable of feeding the world population (a b Bob Goldberg. “The Hypocrisy of Organic Farmers”. AgBioWorld. http://www.agbioworld.org/biotech-info/articles/biotech-art/hypocrisy.html. Retrieved 2007 Oct. 10). Among these critics are Norman Borlaug, father of the “Green Revolution,” and winner of the Nobel Peace Prize, who asserts that organic farming practices can at most feed 4 billion people, after expanding cropland dramatically and destroying ecosystems in the process (a b Andrew Leonard. “Save the rain forest—boycott organic?”. How The World Works. http://www.salon.com/tech/htww/2006/12/11/borlaug/. Retrieved 2007 Oct. 10). Michael Pollan, author of The Omnivore's Dilemma, responds to this by pointing out that the average yield of world agriculture is substantially lower than modern sustainable farming yields. Bringing average world yields up to modern organic levels could increase the world's food supply by 50% (Michael Pollan (2008 Oct. 12). “Chief farmer”. New York Times. http://www.nytimes.com/2008/10/12/magazine/12policy-thtml?pagewanted=5&ei=5070&emc=et al. Retrieved 2008 Nov. 15).

A 2007 study (Perfecto et al., in Renewable Agriculture and Food Systems (2007), 22: 86-108 Cambridge University Press: cited in New Scientist 13:46 12 Jul. 2007) compiling research from 293 different comparisons into a single study to assess the overall efficiency of the two agricultural systems has concluded that . . . organic methods could produce enough food on a global per capita basis to sustain the current human population, and potentially an even larger population, without increasing the agricultural land base. (from the abstract).

The researchers also found that while in developed countries, organic systems on average produce 92% of the yield produced by conventional agriculture, organic systems produce 80% more than conventional farms in developing countries, because the materials needed for organic farming are more accessible than synthetic farming materials to farmers in some poor countries. On the other hand, communities that lack sufficient manure to replenish soils would struggle with organic farming, and the soil would degrade rapidly (“Stuck in the mud”. The Economist. 2008 Aug. 11. http://www.economist.com/daily/columns/greenview/displayStory.cfm?story_id=1191170 6).

A study of the sustainability of apple production systems showed that in comparing a conventional farming system to an organic method of farming, the organic system is more energy efficient (Reganold et al.; Glover, J D; Andrews, P K; Hinman, H R (April 2001). “Sustainability of three apple production systems”. Nature 410 (6831): 926-930. doi:10.1038/35073574. PMID 11309616). However, this is debatable due to organic farming's large use of tillage for weed control. Also increased fuel use from incorporating less nutrient dense fertilizers results in higher fuel consumption rates. The general analysis is that organic production methods are usually more energy efficient because they do not use chemically synthesized nitrogen. But they generally consume more petroleum because of the lack of other options for weed control and more intensive soil management practices.

Energy efficiency is hard to determine; in the case listed above the author cites a book written in 1976. The true value of efficiency and energy consumption in relation to organic farms has yet to be determined.

There are studies detailing the effects and side effects of pesticides upon the health of farm workers (Linda A. McCauley, et al. (2006). “Studying Health Outcomes in Farmworker Populations Exposed to Pesticides”. Environmental Health Perspectives 114. http://www.ehponline.org/members/2006/8526/8526.html). Even when pesticides are organic, and are used correctly, they still end up in the air and bodies of farm workers. Through these studies, organophosphate pesticides have become associated with acute health problems such as abdominal pain, dizziness, headaches, nausea, vomiting, as well as skin and eye problems (Ecobichon DJ. 1996. Toxic effects of pesticides. In: Casarett and Doull's Toxicology: The Basic Science of Poisons (Klaassen C D, Doull J, eds.). 5th ed. New York:MacMillan, 643-689). In addition, there have been many other studies that have found pesticide exposure is associated with more severe health problems such as respiratory problems, memory disorders, dermatologic conditions, (Arcury T A, Quandt S A, Mellen B G (2003). “An exploratory analysis of occupational skin disease among Latino migrant and seasonal farmworkers in North Carolina”. Journal of Agricultural Safety and Health 9 (3): 221-32. PMID 12970952) (O'Malley M A (1997). “Skin reactions to pesticides”. Occupational Medicine 12 (2): 327-345. PMID 9220489) cancer, (Daniels J L, Olshan A F, Savitz D A. (1997). “Pesticides and childhood cancers”. Environmental Health Perspectives (Brogan &#38) 105 (10): 1068-1077. doi:10.2307/3433848. PMID 9349828. PMC 1470375. http://jstor.org/stable/3433848) depression, neurologic deficits, (Kamel F, et al. (2003). “[http://dir.niehs.nih.gov/direb/studies/fwhs/pubs.htm Neurobehavioral performance and work experience in Florida farmworkers”]. Environmental Health Perspectives 111 (14): 1765-1772. doi:10.1289/ehp.6341. PMID 14594629) (Firestone J A, Smith-Weller T, Franklin G, Swanson P, Longsteth W T, Checkoway H. (2005). “Pesticides and risk of Parkinson disease: a population-based case-control study”. Archives of Neurology 62 (1): 91-95. doi:10.1001/archneur.62.1.91. PMID 15642854) miscarriages, and birth defects. (Engel L S, O'Meara E S, Schwartz S M. (2000). “Maternal occupation in agriculture and risk of limb defects in Washington State, 1980-1993”. Scandinavian Journal of Work, Environment & Health 26 (3): 193-198. PMID 10901110. Cordes D H, Rea D F. (1988). “Health hazards of farming”. American Family Physician 38 (4): 233-243. PMID 3051979. Das R, Steege A, Baron S, Beckman J, Harrison R (2001). “Pesticide-related illness among migrant farm workers in the United States” (PDF). International Journal of Occupational and Environmental Health 7 (4): 303-312. PMID 11783860. http://www.dhs.ca.gov/ohb/ohsep/migrantfarmworkers.pdf. Eskenazi B, Bradman A, Castorina R. (1999). “Exposures of children to organophosphate pesticides and their potential adverse health effects”. Environmental Health Perspectives 107: 409-419. PMID 10346990. PMC 1566222. http://www.ehponline.org/members/1999/suppl-3/409-419eskenazi/eskenazi-full.html. Garcia A M (2003). “Pesticide exposure and women's health”. American Journal of Industrial Medicine 44 (6): 584-594. doi:10.1002/ajim.10256. PMID 14635235. Moses M. (1989). “Pesticide-related health problems and farmworkers”. American Association of Occupational Health Nurses 37 (3): 115-130. PMID 2647086. Schwartz D A, Newsum L A, Heifetz R M. (1986). “Parental occupation and birth outcome in an agricultural community”. Scandinavian Journal of Work, Environment & Health 12 (1): 51-54. PMID 3485819. Stallones L, Beseler C. (2002). “Pesticide illness, farm practices, and neurological symptoms among farm residents in Colorado”. Environ Res 90 (2): 89-97. doi:10.1006/enrs.2002.4398. PMID 12483798. Strong, L L, Thompson B, Coronado G D, Griffith W C, Vigoren E M, Islas I. (2004). “Health symptoms and exposure to organophosphate pesticides in farmworkers”. American Journal of Industrial Medicine 46 (6): 599-606. doi:10.1002/ajim.20095. PMID 15551369. Van Maele-Fabry G, Willems J L. (2003). “Occupation related pesticide exposure and cancer of the prostate: a meta-analysis”. Occupational and Environmental Medicine 60 (9): 634-642. doi:10.1136/oem.60.9.634. PMID 12937183. PMC 1740608. http://oem.bmjjournals.com/cgi/content/abstract/60/9/634). Summaries of peer-reviewed research have examined the link between pesticide exposure and neurological outcomes and cancer in organophosphate-exposed workers (Alavanja M C, Hoppin J A, Kamel F. (2004). “Health effects of chronic pesticide exposure: cancer and neurotoxicity”. Annual Review of Public Health 25: 155-197. doi:10.1146/annurev.publhealth.25.101802.123020. PMID 15015917) (Kamel F, Hoppin J A (2004). “Association of pesticide exposure with neurological dysfunction and disease”. Environmental Health Perspectives 112 (9): 950-958. doi:10.1289/ehp.7135. PMID 15198914. PMC 1247187. http://www.medscape.com/viewarticle/481984). Those pesticides found to cause major health problems are banned for use in agriculture, conventional or organic, in many developed counties.

Imported fruits and vegetables from Latin America are more likely to contain high level of pesticides, (“Pesticide levels ‘high in fruit”. BBC. 2004 Jul. 30. http://news.bbc.co.uk/1/hi/sci/tech/3936463.stm. Retrieved 2008 Mar. 30.) even pesticides banned for use in the United States (STUTCHBURY, BRIDGET (2008 Mar. 30). “Did Your Shopping List Kill a Songbird?”. New York Times. http://www.nytimes.com/2008/03/30/opinion/30stutchbury.html. Retrieved 2008 Mar. 30). Migratory birds, such as Swainson's Hawks, have wintering grounds in Argentina where thousands of them were found dead from monocrotophos insecticide poisoning.

A study published by the National Research Council in 1993 determined that for infants and children, the major source of exposure to pesticides is through die (National Research Council (1993). Pesticides in the Diets of Infants and Children (1st ed.). National Academies Press. ISBN 0-309-04875-3). A recent study in 2006 measured the levels of organophosphorus pesticide exposure in 23 schoolchildren before and after replacing their diet with organic food. In this study it was found that levels of organophosphorus pesticide exposure dropped dramatically and immediately when the children switched to an organic diet. (Lu, Chensheng, et al. (2006). “[http://www.ehponline.org/members/2005/8418/8418.pdf Organic Diets Significantly Lower Children's Dietary Exposure to Organophosphorus Pesticides”]. Environmental Health Perspectives 114 (2): 260-263. doi:10.1289/ehp.8418. PMID 16451864). Food residue limits established by law are set specifically with children in mind and consider a child's lifetime ingestion of each pesticide. (“Raw Food” (APA). http://www.kosmix.com/Health/atkins_diet-Alternative_Treatments-Raw_Food/-od-definition_wiki_organic_food-s. Retrieved 2008 Mar. 6).

There are controversial data on the health implications of certain pesticides. For example, the herbicide Atrazine has been shown in some experiments to be a teratogen, causing demasculinization in male frogs exposed to small concentrations. Under the effects of Atrazine, male frogs were found to have greatly increased occurrences of either malformed gonads, or testicular gonads which contain non-degenerate eggs. (Tyrone Hayes, Kelly Haston, Mable Tsui, Anhthu Hoang, Cathryn Haeffele, and Aaron Vonk (2003). “Atrazine-Induced Hermaphroditism at 0.1 ppb in American Leopard Frogs”. Environmental Health Perspectives 111). Effects were however significantly reduced in high concentrations, as is consistent with other teratogens affecting the endocrine system, such as estradiol.

Organic farming standards do not allow the use of synthetic pesticides, but they do allow the use of specific pesticides derived from plants. The most common organic pesticides, accepted for restricted use by most organic standards, include Bt, pyrethrum and rotenone. Rotenone has high toxicity to fish and aquatic creatures, causes Parkinson's disease if injected into rats, and shows other toxicity to mammals. (Pesticide Information Profiles: Rotenone. June, 1996. Pesticide Information Project of Cooperative Extension Offices of Cornell University, Oregon State University, the University of Idaho, and the University of California at Davis and the Institute for Environmental Toxicology, Michigan State University. http://extoxnet.orst.edu/pips/rotenone.htm).

The United States Environmental Protection Agency and state agencies periodically review the licensing of suspect pesticides, but the process of de-listing is slow. One example of this slow process is exemplified by the pesticide Dichlorvos, or DDVP, which as recently as the year 2006 the EPA proposed its continued sale. The EPA has almost banned this pesticide on several occasions since the 1970s, but it never did so despite considerable evidence that suggests DDVP is not only carcinogenic but dangerous to the human nervous system—especially in children. (Raeburn, Paul (2006). “Slow-Acting: After 25 years the EPA still won't ban a risky pesticide”. Scientific American 295: 26). The EPA “has determined that risks do not exceed levels of concern”, (Reregistration Eligibility Decision for Dichlorvos (DDVP) http://www.epa.gov/oppsrrdl/reregistration/REDs/ddvp_red.pdf) a study of long term exposure to DDVP in rats showed no toxic effects. (90 day dermal toxicity of DDVP in male rats, Bulletin of Environmental Contamination and Toxicology http://www.springerlink.com/content/g067605h75k730t2/).

A study published in 2002 showed that “Organically grown foods consistently had about one-third as many residues as conventionally grown foods.” (Baker, Brian; Charles M. Benbrook, Edward Groth III, and Karen Lutz Benbrook. “Pesticide residues in conventional, IPM-grown and organic foods: Insights from three U.S. data sets.”. Food Additives and Contaminants 19 (5): 427-446. doi:10.1080/02652030110113799. PMID 12028642. http://www.consumersunion.org/food/organicsumm.htm. Retrieved 2007 Jan. 28.). (Goldberg, Adam (2002 May 8). “Consumers Union Research Team Shows: Organic Foods Really DO Have Less Pesticides”. Consumers Union. http://www.consumersunion.org/food/organicpr.htm. Retrieved 2007 Jan. 27).

Monitoring of pesticide residues in the United States is carried out by the Pesticide Data Program, a branch of the USDA created in 1990. It has since tested over 60 different types of food for over 400 different types of pesticides—with samples collected close to the point of consumption. Their most recent results found in 2005 that:
These data indicate that 29.5 percent of all samples tested contained no detectable pesticides [parent compound and metabolite(s) combined], 30 percent contained 1 pesticide, and slightly over 40 percent contained more than 1 pesticide.
   —USDA, Pesticide Data Program
      (Pesticide Data Program (February 2006) (pdf). Annual Summary Calendar Year 2005. USDA. http://www.ams.usda.gov/science/pdp/Summary2005.pdf. Retrieved 2006 Jul. 24)

Several studies corroborate this finding by having found that 25 percent of organic food carries synthetic pesticide residues, in comparison to 77 percent of conventional food. Consumers Union. Dec. 15, 1997. Are organic foods as good as they're grown? A landmark consumer reports study. Consumers Union Press Release. “One-quarter of the organic produce samples that Consumer Reports tested had some pesticide residues on them, compared with 77 percent of the conventional samples.” (Consumers Union. January, 1998. Greener Greens: The Truth About Organic Food. Consumer Reports 63(1): pages 12-18). (Baker et al. May, 2002. Pesticide residues in conventional, IPM-grown and organic foods: Insights from three U.S. data sets. Summary: Analysis and Results: Frequency of Positive Samples. Food Additives and Contaminants: volume 19, No. 5, pages 427-446. “Frequency of Positive Samples: Organically grown samples consistently had far smaller percentages with residues: 23, 6.5 and 27 percent in the USDA, DPR and CU data, respectively.”). (Environmental Science & Technology Online. Jan. 11, 2006. Organic vegetables not pesticide-free. Science News). (COMPLIANCE SUMMARY FOR FRESH FRUIT AND VEGETABLE COMMODITIES). (Monitoring of imported processed fruit and vegetable products by specific commodity, country and tests). (Fresh fruit and vegetables). ([http://www.inspection.gc.ca/english/fssa/microchem/resid/2003-2004/plaveg_pte.shtml Report On Pesticides, Agricultural Chemicals, Environmental Pollutants and Other Impurities in Agri-Food Commodities of Plant Origin]). (Dairy products). (Canadian Food Inspection Agency. 2003. Report on Pesticides Residues in Baby Food 2002-2003. Infant and Junior Baby Food Chemical Residues Project).

In April 2009, results from Quality Low Input Food (QLIF), a 5-year integrated study funded by the European Commission, (“Quality Low Input Food Project” (APA). http://ec.europa.eu/research/research-for-europe/agriculture-quality-low-input-food_en.html. Retrieved 2009 Nov. 23) confirmed that “the quality of crops and livestock products from organic and conventional farming systems differs considerably.” (a b Niggli, Urs et al. (2009). “QLIF Integrated Research Project: Advancing Organic and Low-Input Food.” [1] Retrieved on 23 Nov. 2009). Specifically, results from a QLIF project studying the effects of organic and low-input farming on crop and livestock nutritional quality “showed that organic food production methods resulted in some case: (a) higher levels of nutritionally desirable compounds (e.g., vitamins/antioxidants and poly-unsaturated fatty acids such as omega-3 and CLA); (b) lower levels of nutritionally Bourn D, Prescott J. January 2002. A comparison of the nutritional value, sensory qualities, and food safety of organically and conventionally produced foods Critical Reviews in Food Science Nutrition. 42(1): 1-34. (Williams, C. M. February 2002. Nutritional quality of organic food: shades of grey or shades of green? Proceedings of the Nutrition Society. 61(1): 19-24). (Canadian Produce Marketing Association (CPMA). Organically Grown Produce: Does organic produce taste better? & Is organic produce more nutritious?). (Sir John Krebs. Jun. 5, 2003. Is organic food better for you? Speech given by the then-chair of the Food Standards Agency (UK), Sir John Krebs, to the Cheltenham Science Fair on Jun. 5, 2005. Posted on the Food Standards Agency website: http://www.food.gov.uk/news/newsarchive/2003/jun/cheltenham), undesirable compounds such as heavy metals, mycotoxins, pesticide residues and glyco-alkaloids in a range of crops and/or milk; (c) a lower risk of faecal Salmonella shedding in pigs.” but also showed no significant difference between traditionally grown foods on other studies. (Leifert, Carlo & Lars Elsgaard. (2009). “QLIF Subproject 2: Effects of Production Methods: Determining the Effect of Organic and Low-Input Production Methods on Food Quality and Safety.” [2] Retrieved on 23 Nov. 2009). The QLIF study also concludes that “further and more detailed studies are required to provide proof for positive health impacts of organic diets on human and animal health.” (a b Niggli, Urs et al. (2009). “QLIF Integrated Research Project: Advancing Organic and Low-Input Food.” [1] Retrieved on 23 Nov. 2009). Alternatively, according to the UK's Food Standards Agency, “Consumers may choose to buy organic fruit, vegetables and meat because they believe them to be more nutritious than other food. However, the balance of current scientific evidence does not support this view.” (The Food Standards Agency's Current Stance). A 12-month systematic review commissioned by the FSA in 2009 and conducted at the London School of Hygiene & Tropical Medicine based on 50 years' worth of collected evidence concluded that “there is no good evidence that consumption of organic food is beneficial to health in relation to nutrient content.” (Sophie Goodchild (2009 July). “Organic food ‘no healthier’ blow”. London Evening Standard. http://www.thisislondon.co.uk/standard/article-23725592-details/article.do. Retrieved 2009 Jul. 29). Other studies have found no proof that organic food offers greater nutritional values, more consumer safety or any distinguishable difference in taste. A recent review of nutrition claims showed that organic food proponents are unreliable information sources which harm consumers, and that consumers are wasting their money if they buy organic food believing that that it contains better nutrients. (Rosen, “A Review of the Nutrition Claims Made by Proponents of Organic Food”, Comprehensive Reviews In Food Science And Safety, [3]).

Regarding taste, a 2001 study concluded that organic apples were sweeter by blind taste test. Firmness of the apples was also rated higher than those grown conventionally. (Reganold, John (2001). Sustainability of Organic, Conventional, and Integrated Apple Orchards). Current studies have not found differences in the amounts of natural biotoxins between organic and conventional foods. (Swedish National Food Administration->Ekologisk mat Translated from: I studierna går det heller inte att påvisa några skillnader mellan ekologiskt och konventionellt odlade produkter när det gäller halter av naturliga gifter, till exempel mögelgifter, i spannmål eller solanin i potatis. Retrieved on Jun. 11, 2009).

Organic products typically cost 10 to 40% more than similar conventionally produced products. (Winter, C K and S F Davis, 2006 “Organic Foods” Journal of Food Science 71(9):R117-R124). According to the USDA, Americans, on average, spent $1,347 on groceries in 2004; (Food Spending in American Households, 2003 April) thus switching entirely to organics would raise their cost of groceries by about $135 to $539 per year ($11 to $45 per month). Processed organic foods vary in price when compared to their conventional counterparts. An Australian study by Choice magazine in 2004 found processed organic foods in supermarkets to be 65% more expensive, but noted this was not consistent. Prices may be higher because organic produce is produced on a smaller scale, and may need to be milled or processed separately. Furthermore, there is an increase in shipping costs from more centralized production in otherwise regional markets. In the case of dairy and eggs, the animal's requirements such as the number of animals that can be raised per acre, or the breed of animal and its feed conversion ratio affects the costs.

Biodynamic agriculture, a method of organic farming, is closely related to the organic food movement.

Food Co-ops and buyers groups are alternative ways of selling food which have also been closely related to the organic food movement. These co-operative structures have been aimed at lowering the retail price of organic food and some attempt to reduce the food miles associated with the produce.

While organic food accounts for 1-2% of total food sales worldwide, the organic food market is growing rapidly, far ahead of the rest of the food industry, in both developed and developing nations.

Milk Derivative Products—Such as, but not limited to, milk, butter, cheese, cottage cheese, sour cream, yogurt, etc.

Low Temperature Batch or VAT Pasteurization—Pasteurization is a mandated production method for milks in the United States where heat is applied to raw milk to decrease the possibility of food-borne illness and to increase shelf life. The practitioners of the present invention uses a process called VAT pasteurization (aka batch pasteurization), where a fixed volume of milk in a vat is slowly agitated at 145 degrees Fahrenheit—this process has a uniquely negligible effect on the pure flavor of the milk. The end product is as close as pasteurized milk can get to farm fresh flavor. The practitioners of the present invention also chooses the VAT process because they believe its lower temperature allows milk to retain more of its nutritional value than other methods of pasteurization (industrial-scale milk operations heat their milk to 171 degrees or higher, Fahrenheit, HTST method, and from 265-300 degrees, Fahrenheit, UHT method). The difference is very easy to understand; overcooked food loses flavor and nutrients. A well known example of the impact cooking has on food is its effect on vegetables. Raw or gently cooked vegetables have more flavor and nutrients than overcooked vegetables. The practitioners of the present invention believe the same is likely true for milk. Most milk available today is pasteurized at temperatures significantly higher than 145 degrees Fahrenheit. By doing this, dairies sacrifice the fresh flavor and nutritional value of milk for a longer-than-natural shelf life. The practitioners of the present invention do not homogenize our milk, preferring instead to leave it in its natural form—a combination of nonfat milk and cream. Homogenization, developed around 1900 in France, is a process in which hot milk is pumped through very small nozzles at high pressure, creating turbulent pressure that tears the fat globules into tiny particles, evenly dispersing them throughout the milk. While homogenization blends milk, it makes milk taste bland. Cream left in its whole form (globules) allows a natural creamy taste that is lost when it is broken down through homogenization. The cream in non-homogenized milk will rise to the top because it is lighter than the nonfat milk from which it separates. As a further example of the minimally processed concept applied to milk is the question of fortifying with Vitamin D. While Vitamin D fortification of milk is common, the practitioners of the present invention chose not to fortify our milk because they believe that food should be eaten as close to its natural state as possible. The following information from our nutrition consultant, Jessica Forbes, MS CCN, also informed our decision to not add Vitamin D to our milk.

“Fortified milk contains a mixture of Vitamin D2 (ergocalciferol—synthetic Vitamin D) and Vitamin D3 (cholecalciferol—activated Vitamin D). Synthetic Vitamin D has been linked to heart disease, hyperactivity, and allergic reactions and may be toxic in large doses. Our milk naturally contains small amounts of Vitamin D3. The rest of a person's Vitamin D needs should be easily obtained by regularly eating D-rich foods including pastured eggs, fatty fish such as mackerel, cod, and salmon and by spending at least 45 minutes per week outside with face and arms exposed to sunlight. By way of comparison, a cup of fortified milk contains 100 IU Vitamin D while a fair-skinned person can make 15,000 IU or more during 30 minutes of sun exposure. Vitamin D production is different for each person depending on their complexion, sun exposure, and where they live. If you feel you need to supplement with additional Vitamin D, we suggest incorporating cod liver oil into your routine as a whole food source of Vitamin D3.”

This is a detailed example of how minimally processed foods have the highest quality.

Kosher—The practitioners of the present invention, which is centered on minimally processing foods, also work to certify their foods meet Kosher standards.

Kosher food is food that conform to the regulations of the Jewish Halakhic law framework. These rules form the main aspect of kashrut, Jewish dietary laws.

A list of some Kosher foods are found in the book of Leviticus. There are also certain Kosher rules which are found there.

Reasons for food being non-kosher include the presence of ingredients derived from non-kosher animals or from kosher animals that were not properly slaughtered, a mixture of meat and milk, wine or grape juice (or their derivatives) produced without supervision, the use of produce from Israel that has not been tithed, or even the use of cooking utensils and machinery which had previously been used for non-kosher food. These might include utensils and machines used for processing pork or other non-kosher foods. In addition, foods deemed by the rabbis to be “fit for a king's table” must have their cooking supervised by a Jew in order to be kosher.

In Judaism many of the laws of Kashrut pertain to animals. The Torah states which animals are permitted and forbidden. In regard to birds, the Torah provides no general rule, and instead the Deuteronomic Code and Priestly Code explicitly list the prohibited birds, using names that have uncertain translations; the list seems to mainly consist of birds of prey, fish-eating water-birds, and bats (which are mammals). Fowl (birds) known to be kosher also achieve that status from transmission of information in that regard from generation to generation, and this is known as mesora, or tradition.

By contrast, for water creatures, Leviticus and Deuteronomy both give the general rule that anything residing in the waters (which Leviticus specifies as being the seas and rivers) is ritually clean if it has both fins and scales, (Leviticus 11:9) (Deuteronomy 14:9) in contrast to anything residing in the waters with neither fins nor scales, (Leviticus 11:10) (Deuteronomy 14:10) which Leviticus calls filthy (Leviticus 11:10) (Hebrew: sheqets). All flying creeping things were also to be considered ritually unclean, (Deuteronomy 14:19), (Leviticus 11:20) according to both Leviticus and Deuteronomy, but unlike Deuteronomy, Leviticus identifies four exceptions; the exceptions are of uncertain translation, but are clearly locusts and similar creatures, and there is a tradition upheld by Jews from Yemen about which animals constitute the kosher locusts.

With regard to land beasts (Hebrew:Behemoth), Deuteronomy and Leviticus both state that anything which chews the cud and has a cloven hoof would be ritually clean, but those animals which only chew the cud or only have cloven hooves would be unclean. (Leviticus 11:3-4) (Deuteronomy 14:6-7). The texts identify four animals in particular as being unclean for this reason—the hare, hyrax, camel, and pig—although the camel both ruminates and has two toes, while the hare and hyrax are coprophages rather than ruminants; the latter issues have been discussed by many, including the recent book on the subject by Rabbi Natan Slifkin. (Natan Slifkin, The Camel, the Hare and the Hyrax). Leviticus, but not Deuteronomy, also states that every creeping thing which creeps upon the earth should be considered ‘filthy’ (Hebrew: sheqets). (Leviticus 11:41).

One of the main biblical food laws forbids eating blood on account of the life [being] in the blood. This ban and reason are listed in the Noahide Laws (Genesis 9:4) and twice in Leviticus (Leviticus 3:17) (Leviticus 17:11) as well as in Deuteronomy. (Deuteronomy 12:16). The Priestly Code also prohibits the eating of certain types of fat (chelev) from sacrificial land animals (cattle, sheep, and goats), since the fat is the portion of the meat exclusively allocated to YHWH (by burning it on the altar). (Leviticus 7:23-25).

The classical rabbis argued that, in a number of cases, the prohibition against consuming blood was impractical, and there should be exceptions: they claimed that consuming the blood which remained on the inside of meat (as opposed to the blood on the surface of it, dripping from it, or housed within the veins) should be permitted and that the blood of fish and locusts could also be consumed. (Keritot 2a) (Keritot 20b) (Hullin 111a) (Hullin 117a).

To comply with this prohibition, a number of preparation techniques became practiced within traditional Judaism. The main technique, known as melihah, involves the meat being soaked in water for about half an hour, which opens pores. (a b c d Jewish Encyclopedia, Melihah). After this, the meat is placed on a slanted board or in a wicker basket and is thickly covered with salt on each side, then left for between twenty minutes and one hour. (a b Genesis 32:32). The salt covering draws blood from the meat by osmosis, and the salt must be subsequently removed from the meat (usually by trying to shake most of it off and then washing the meat twice (a b c d Jewish Encyclopedia, Melihah)) in order to complete the extraction of the blood.

Melihah is not sufficient to extract blood from the liver, lungs, heart, and certain other internal organs, since they naturally contain a high density of blood, and therefore these organs are usually removed before the rest of the meat is salted. Roasting, on the other hand, discharges blood, and is the usual treatment given to these organs (if they are to be eaten at all). It is also an alternative cooking method for the rest of the meat. (a b c d Jewish Encyclopedia, Melihah).]

The Bible mentions in passing that there was an Israelite tradition of not eating the sinew which shrank upon the hollow of the thigh, (a b Genesis 32:32) but the Talmud interprets this as an explicit prohibition against doing so; (Hullin 100b) the Bible attributes the tradition to the dislocation of the hollow of Jacob's thigh while wrestling with an angel, in a biblical narrative set at Penuel. (a b Genesis 32:32). Within Judaism the rule has usually been interpreted as referring to the sciatic nerve, the removal of which is a very time-consuming process demanding a great deal of special training; therefore cuts from an animal's hindquarters (including the Filet mignon) are generally not sold as kosher. Why can't I find kosher filet mignon?—Kosher Q&A). The Talmud excludes bird meat from the restriction. (a b Jewish Encyclopedia, Dietary Laws).

In addition to meat, all other produce of ritually unclean animals, as well as from unhealthy animals, were banned by the Talmudic writers; (Bekorot 5b) this included eggs (including fish roe) (Abodah Zarah 40a) (Maimonides Yad, Ma'akalot Asuro:20-24) (Jacob ben Asher, Yoreh De'ah, 83:5-10) and milk, (Jewish Encyclopedia) as well as derived products such as cheese and jelly, (a b Jewish Encyclopedia, Dietary Laws) but did not include materials merely manufactured or gathered by animals, such as honey (although, in the case of honey from animals other than bees, there was a difference of opinion among the ancient writers). (Bekorot 7b) (a b c Maimonides Yad, Ma'akalot Asuro:3) (Jacob ben Asher, Yoreh De'ah, 8-9). According to the rabbinical writers, eggs from ritually pure animals would always be prolate (“pointy”) at one end and oblate (“rounded”) at the other, helping to reduce uncertainty about whether consumption was permitted or not. (Hullin 64a) (Maimonides Yad, Ma'akalot Asuro:7-11) (Jacob ben Asher, Yoreh De'ah, 86).

The classical rabbinical writers imply that milk from an animal whose meat is kosher is also kosher. As animals are considered non-kosher if after being slaughtered they are discovered to have been diseased, this could make their milk retro-actively non-kosher. However, by adhering to the principle that the majority case overrules the exception, Jewish tradition continues to regard such milk as kosher, since statistically it is true that most animals producing such milk are kosher; the same principle is not applied to the possibility of consuming meat from an animal which has not been checked for disease. Rabbi Hershel Schachter, a prominent rosh yeshiva at Yeshiva University, has made the bold claim that with modern dairy farm equipment, milk from the minority of non-kosher cows is invariably mixed with that of the majority of kosher cows, thus invalidating the permissibility of consuming milk from a large dairy operation; the Orthodox Union, however, released a statement declaring the milk permissible based on some leniencies.

The Shulchan Aruch (Yoreh De'ah 115:1) rules one may consume only “cholov yisroel” ( [symbol] ), or milk produced with a Torah-observant Jewish person present. Lacking proper supervision, one cannot be sure whether the milk came from a kosher animal. (OK Kosher Certification—The Making of Chalav Yisroel). Some recent American rabbinical authorities, most notably Rabbi Moshe Feinstein, ruled that the protection provided by cholov yisroel is unnecessary because the regulations imposed on the US milk industry by the USDA are so focused and strict that the milk industry can be trusted to self-regulate (i.e. when they label an item “cow's milk” to not include milk from any other animal). Some Haredi and Modern Orthodox rabbis hold that this leniency cannot be employed and only milk and dairy products with milk-to-bottle supervision may be consumed.

The custom arose in Talmudic times not to eat dairy after meat, but the length of time needed to elapse differs by community. Dutch Jews wait an hour, probably on the idea that that separation makes clear that the dairy is a separate ‘meal’. German Jews wait three hours, and Eastern European Jews typically wait six hours or in some cases into the sixth hour.

The situation of cheese is complicated by the fact that the production of hard cheese usually involves rennet, an enzyme which splits milk into curds and whey. Although rennet can be made from vegetable or microbial sources, most forms are derived from the stomach linings of animals, and therefore could potentially be non-kosher. Only rennet made from the stomachs of kosher-animals, if they have been slaughtered according to the laws of kashrut, is kosher. If a kosher animal is not slaughtered according to the halakha, the rennet is not kosher. Rennet is not considered a meat product and does not violate the prohibition of mixing meat and dairy.

Jacob ben Meir, one of the most prominent medieval rabbis, championed the viewpoint that all cheese was kosher, a standpoint which was practiced in communities in Narbonne and Italy. Contemporary Orthodox authorities do not follow this ruling, and hold that cheese requires formal kashrut certification to be kosher, some even arguing that this is necessary for cheese made with non-animal rennet. In practice, Orthodox Jews, and some Conservative Jews who observe the kashrut laws, only eat cheese if they are certain that the rennet itself was kosher.

Gelatin is also a product with complicated implications for Orthodox Jews. Gelatin is hydrolyzed collagen, the main protein in animal connective tissue, and therefore could potentially come from a non-kosher source, such as pig skin. Gelatin has historically been a prominent source of glue, finding uses from musical instruments to embroidery, one of the main historic emulsions used in cosmetics and in photographic film, the main coating given to medical capsule pills, and a form of food including jelly, trifle, and marshmallows; the status of gelatin in kashrut is consequently fairly controversial.

Due to the ambiguity over the source of individual items derived from gelatin, many Orthodox rabbis regard it as generally being non-kosher. However, Conservative rabbis (United Synagogue of Conservative Judaism, Keeping Kosher: A Diet For the Soul (2000)) and several prominent Orthodox rabbis, including, Chaim Ozer Grodzinski, and Ovadia Yosef—the former Sephardic Chief Rabbi of Israel—argue that gelatin has undergone such total chemical change and processing that it should not count as meat, and therefore would be kosher; (Yabia Omer, Vol. 8; Yoreh De'ah No. 11) technically, gelatin is just produced by separating the three strands in each collagen fibre's triple helix, an action performed simply by boiling collagen in water. Rabbi Dr. David Sheinkopf, author of “Gelatin in Jewish Law” (Bloch 1982) and “Issues in “Jewish Dietary Laws” (Ktav 1998), has published in depth studies of the kosher uses of gelatin as well as carmine and kitniyyot.

One of the main methods of avoiding non-kosher gelatin is to substitute gelatin-like materials in its place; substances with a similar chemical behavior include food starch from tapioca, chemically modified pectins, and carrageenan combined with certain vegetable gums—guar gum, locust bean gum, xanthan gum, gum acacia, agar, and others. Although gelatin is used for several purposes by a wide variety of manufacturers, it has started to be replaced with these substitutes in a number of products, due to the use of gelatin also being a significant concern to vegans.

Of the rules appearing, in two groups, in Exodus, most do not express dietary laws, but one of the few dietary rules it does list is a ban on eating the meat from animals which have been “torn by beasts”; (Exodus 22:30) a related law appears in Deuteronomy's law code, totally prohibiting the consumption of anything that has died from natural causes, and even giving away or selling such things. (Deuteronomy 14:21). The Book of Ezekiel implies (Jewish Encyclopedia, Carcass) that the rules about animals which die of natural causes, or are “torn by beasts,” were only adhered to by the priests, (Ezekiel 4:14) and were only intended for them; (Ezekiel 44:31) the implication that they did not apply to, and were not upheld by, ordinary Israelites was noticed by the classical rabbis, who declared that “the prophet Elijah shall some day explain this problematic passage”. (Menahot 45a).

Since the Bible prohibits eating meat from animals dying from natural causes, and all animals killed by beasts, traditional Jewish thought has expressed the view that all meat must come from animals which have been slaughtered according to Jewish law. These strict guidelines require that the animal is killed by a single cut across the throat to a precise depth, severing both carotid arteries, both jugular veins, both vagus nerves, the trachea and the esophagus, no higher than the epiglottis and no lower than where cilia begin inside the trachea, causing the animal to bleed to death. Orthodox Jews argue that this ensures the animal dies instantly without unnecessary suffering, but many animal rights activists view the process as cruel, arguing that the animal may not lose consciousness immediately, and activists have called for it to be banned. (a b Sheep killing branded cruel—The Age) (“Halal and Kosher slaughter ‘must end’”. BBC News. 2003 June 10. http://news.bbc.co.uk/1/hi/uk/2977086.stm. Retrieved 2010 May 7.).

To avoid tearing, and to ensure the cut is thorough, such slaughter is usually performed by a trained individual, with a large razor-sharp knife, which is checked before each killing to ensure that it has no irregularities (such as nicks and dents); if irregularities are discovered, or the cut is too shallow, the meat is deemed not kosher, and is sold to the non-Jewish public. Rabbis usually require the slaughterer, known within Judaism as a shochet, to also be a pious Jew of good character, who observes the Shabbat, and believes that the slaughter victims are sacrificing their lives for the good of the slaughterer and their community. In smaller communities the shochet was often the town rabbi, or a rabbi from a local synagogue, but large slaughterhouses usually employ a full-time shochet if they intend to sell kosher meat.

The Talmud, and later Jewish authorities, also prohibit the consumption of meat from animals who were slaughtered despite being in the process of dying from disease; but this is not based on concern for the health of the eater, instead being an extension of the rules banning the meat from animals “torn by beasts,” and animals who die from natural causes. (Hullin 3) (Maimonides Yad, Ma'akalot Asuro:5-11) (Jacob ben Asher, Yoreh De'ah 29-60). To comply with this Talmudic injunction against eating diseased animals, Orthodox Jews usually require that the corpses of freshly slaughtered animals are thoroughly inspected. There are 70 different traditional checks for irregularities and growths; for example, there are checks to ensure that the lungs have absolutely no scars, which might have been caused by an inflammation. If these checks are passed the meat is then termed glatt ( [symbol] ), literally meaning smooth.

Compromises in countries with animal cruelty laws that prohibit such practices involve stunning the animal to lessen the suffering that occurs while the animal bleeds to death. However, the use of electric shocks to daze the animal is often not accepted by some markets as producing meat which is kosher. (a b Sheep killing branded cruel—The Age).

The Talmud prohibits the consumption of animals which are still alive. Sanhedrin 56a). The consumption of eggs which have started to hatch was regarded as falling under the ban on eating parts of live animals; the Yoreh De'ah argues that if there is blood in the yolk then hatching must have begun, and therefore consumption of the egg would be forbidden. (Jacob ben Asher, Yoreh De'ah 66).

Modern Orthodox Jews adhere to these requirements, but although the Ashkenazi Orthodox Jews treat an egg as non-kosher if blood is found anywhere within it, the Sephardi Orthodox Jews only consider blood in the yolk to be a problem; the Sephardi treat eggs with blood in the albumen as legitimate food, if the blood is removed before use.

Three times the Torah specifically forbids seething a young goat in its mother's milk (Exodus 23:19, Exodus 34:26, and Deuteronomy 14:21). The Talmud interprets this as a general prohibition against cooking meat and dairy products together, and against eating such a mixture. To help prevent accidental violation of these rules, the modern standard Orthodox practice is to classify food into either being meat, dairy, or neither; the latter category is more usually referred to as parve from the Yiddish word parev ( [symbol] ) (also spelled “pareve”) meaning neutral. As the biblical prohibition specifically refers to (young) goats, the flesh of mammals is logically categorized as meat, while that of fish is considered parve; however, rather than being considered parve, the flesh of birds is regarded by Modern halakha (Jewish law) as meat, though only by Rabbinic decree.

The classical rabbis prohibited any item of food that had been consecrated to an idol, or had been used in the service of an idol; (Abodah Zarah 29b) since the Talmud views all non-Jews as idolaters, and viewed intermarriage with apprehension, it included within this prohibition any food which has been cooked/prepared completely by non-Jews. (a b Abodah Zarah 35b) (a b Abodah Zarah 38a). However, bread sold by a non-Jewish baker was not included in the prohibition; (a b Abodah Zarah 35b) (a b Abodah Zarah 38a) similarly, a number of Jewish writers believed that food prepared on behalf of Jews, by non-Jewish servants, would not count as idolatry, although this view was opposed by Jacob ben Asher. (Jacob ben Asher, Yoreh De'ah, 113:4).

Consequently, modern Orthodox Jews generally believe that wine, cheese, certain cooked foods, and sometimes even dairy products, (http://www.koltorah.org/RAVJ/13-7%20Chalav%20Yisrael%20-%20 Part%201.htm) (http://www.koltorah.org/RAVJ/13-8%20Chalav%20Yisrael%20-%20 Part%202.htm) (http://www.koltorah.org/RAVJ/13-9%20Chalav%20Yisrael%20-%20 Part%203.htm) should only be prepared by Jews. The prohibition against drinking non-Jewish wine, traditionally called yayin nesekh (literally meaning wine for offering [to a deity]), is not absolute. Cooked wine (Hebrew: yayin mevushal), meaning wine which has been heated, is regarded as drinkable on the basis that heated wine was not historically used as a religious libation; thus kosher wine includes mulled wine, and pasteurized wine, regardless of producer, but Orthodox Judaism only regards other forms of wine as kosher if prepared by a Jew.

Some Jews refer to these prohibited foods as akum, an acronym of Obhde Kokhabkim U Mazzaloth, meaning worshippers of stars and planets; akum is thus a reference to activities which these Jews view as idolatry, and in many significant works of post-classical Jewish literature, such as the Shulchan Aruch, it has been applied to Christians in particular. However, among the classical rabbis, there were a number who refused to treat Christians as idolaters, and consequently regarded food which had been manufactured by them as being kosher; this detail has been noted and upheld by a number of religious authorities in Conservative Judaism, such as Rabbi Israel Silverman, and Rabbi Elliot N. Dorff.

Conservative Judaism is more lenient; in the 1960s, Rabbi Israel Silverman issued a responsum, officially approved by the Committee on Jewish Law and Standards, in which he argued that wine manufactured by an automated process was not manufactured by gentiles, and therefore would be kosher. A later responsum of Conservative Judaism was issued by Rabbi Elliott Dorff, who argued, based on precedents in 15th-19th century responsa, that many foods, such as wheat and oil products, which had once been forbidden when produced by non-Jews, were eventually declared kosher; on this basis he concluded that wine and grape products produced by non-Jews would be permissible.

For obvious reasons, the Talmud adds to the biblical regulations a prohibition against consuming poisoned animals. (Hullin 58b). Similarly the Yoreh De'ah prohibits the drinking of water, if the water had been left overnight and uncovered in an area where there might be serpents, on the basis that a serpent might have left its venom in the water. (Jacob ben Asher, Yoreh De'ah 29-60).

A concern for the health of the eater is also behind the instigation, by the Talmud and Yoreh Deah, to never eat or cook fish with meat, and instead ensure that the mouth is washed between consuming fish and consuming meat; these texts explain that the prohibition is for the purpose of avoiding tzaraat (or tzaraas)—a disease which the texts suggest would be caused by eating meat and fish together. (Pesahim 66b) (Yoreh De'ah 117). Tzaraat was a bodily affliction that is often translated loosely as leprosy; this translation can prove problematic because, in the scientific realm, leprosy is caused by a parasitic species of bacterium Mycobacterium leprae, and has no other instigation, such as eating fish and meat together. Those who take on stricter observances, such as Orthodox Jews, continue to follow this ban, (Luban, Rabbi Yaakov. “The Kosher Primer”. oukosher.org. Orthodox Union. http://www.oukosher.org/index.php/prolearn/kosher_primer. Retrieved 2007 Jun. 1); (a b Shulman, Shlomo (2006 Jul. 7). “Mixing Fish and Meat”. jewishanswers.org. Project Genesis. http://www.jewishanswers.org/ask-the-rabbi-996/mixing-fish-and-meat/. Retrieved 2007 Jun. 1), while other denominations, such as Conservative Jews may or may not. (a b Shulman, Shlomo (2006 Jul. 7). “Mixing Fish and Meat”. jewishanswers.org. Project Genesis. http://www.jewishanswers.org/ask-the-rabbi-996/mixing-fish-and-meat/. Retrieved 2007 Jun. 1).

The Book of Genesis implies that there were no restrictions on any fruit, cereal, nuts, or other vegetable matter growing upon the earth. (Genesis 1:29). However, Leviticus forbids the consumption of fruit from trees which are less than three years old, (Leviticus 19:23-25) and the eating of any grain which is too young to have been ready for harvest before the previous Passover; (Leviticus 23:9-14) the latter rule is known as Yoshon, roughly meaning old, and the former is known as Orlah, meaning foreskin, due to the biblical instruction that young trees should metaphorically be considered to be uncircumcised. (Leviticus 19:23). A related biblical rule argues that the first of the first fruits should be brought to sanctuaries. (Exodus 23:19).

Orthodox Jews generally adhere to these rules, but only for the produce of Israel, to which they believe it exclusively applies. Most Orthodox Jews also adhere to Joseph Caro's view that agricultural produce would not be non-kosher if the Levite Tithe has not been exacted from it, nor if it has been harvested during a Sabbatical Year. (Joseph Caro, Shulchan Aruch, Yoreh De'ah:391-393).

All fresh fruits and vegetables are kosher in principle. Jewish law requires that they be carefully checked and cleaned to make sure that there are no insects on them, as insects are not kosher (except certain grasshoppers and crickets according to the Jews of Yemen only, see main article). The Orthodox community is particular not to consume produce which may have insect infestation, and check and wash certain forms of produce very carefully. Many Orthodox Jews avoid certain vegetables, such as broccoli, because they may be infested and exceedingly hard to clean. Some kashrut certifying organizations completely recommend against consumption of certain vegetables they deem impossible to clean.

According to the U.S. Dept. of Agriculture, commercially it is not possible to remove all insects, and a sizable amount remain. Responding to this issue, some companies now sell thoroughly washed and inspected produce for those who do not wish to do it themselves, even going to the trouble of filtering the wash water to ensure that it carries no microscopic creatures [see discussion of such animals in tap water, above]. These may or may not meet rabbinical standards for being insect-free.

According to the U.S. Dept. of Agriculture, commercially it is not possible to remove all insects, and a sizable amount remain. Responding to this issue, some companies now sell thoroughly washed and inspected produce for those who do not wish to do it themselves, even going to the trouble of filtering the wash water to ensure that it carries no microscopic creatures [see discussion of such animals in tap water, above]. These may or may not meet rabbinical standards for be Processed items (e.g. dry cereals, baked goods, canned fruits and vegetables, frozen vegetables, and dried fruit such as raisins) can also include small quantities of non-kosher ingredients. This is because these items are often cooked and processed in factories using equipment that is also used for non-kosher foods, or may involve containers used for processing that have been greased with animal fats. Sometimes additives are introduced, and fruits or vegetables may have been prepared with milk products or with ingredients such as non-kosher meat broths.

For these reasons, Orthodox rabbis advise against consuming such products without a hechsher (mark of rabbinical certification of kashrut) being on the product. By contrast, some Conservative rabbis regard a careful reading of the ingredients to be a sufficient precaution. However, certain processed foods are usually regarded (by most Jews) as being an exception: plain tea, salt, 100% cocoa, carbonated water, some frozen fruits, including berries, and coffee, have only very basic processing from their natural state; these fruits are often frozen in their natural form and then bagged, while carbonated water is generally the addition of carbon dioxide to natural water.

During Passover, there are additional food restrictions in Judaism; leavened products are prohibited during the festival. Jews who are concerned about accidentally consuming leavened food, during passover, typically maintain an entirely separate set of crockery and cutlery for Passover; it is also common for those concerned about such things to rigorously clean their homes, to ensure that even the tiniest of remains of leavened products are removed.

Products made from the traditional five species of grain, which might have been inadvertently moistened after harvest, and thus begun to ferment (an aspect of the leavening process), are regarded as prohibited during Passover; the five species are conventionally viewed to be wheat, rye, barley, spelt and oats, although the latter two may actually refer to emmer (sometimes confused with spelt, which did not historically grow in the Middle East) and two-rowed barley.

Among Ashkenazi Jews there is an additional customary practice of avoiding the consumption of kitniyot (literally meaning little things) during Passover; the list of items regarded as kitniyot varies between communities, and can include things such as rice, legumes (including peas, peanuts, and beans), and corn. Due to the prevalence of corn syrup in certain well-known processed foods, such as Coca-Cola, many items common in Western countries are regarded as impermissible by Ashkenazic Jews during Passover. [For Passover consumption, some companies produce products similar to their standard versions but with Kosher-for-Passover ingredients. Coca-Cola, for example, produces and distributes kosher for Passover Coke, made with cane sugar instead of corn syrup, in the U.S. during Passover since Rabbi Tobias Geffen certified Coca-Cola as kosher 1935. (Geffen, Tobias (1935). “A Teshuvah Concerning Coca Cola” (PDF). Karnei Hahod. HebrewBooks.org. pp. 3. http://hebrewbooks.org/pdfpager.aspx?req=2227&pgnum=3); (Feldberg, Michael (ed.) (2002). “Beyond Seltzer Water: The Kashering of Coca-Cola”. Blessings of Freedom: Chapters in American Jewish History. New York: American Jewish Historical Society. ISBN 0-88125-756-7. http://www.ajhs.org/scholarship/chapters/chapter.cfm?documentID=270).

Super Kosher—Super Kosher is a term used by the practitioners of the present invention to describe Cholov Yisroel.

Cholov Yisroel refers to all dairy products, including cheese and non-fat dry milk powder, which have been produced under the supervision of a Jew.

Under Jewish halachic law, milk is kosher only if it comes from a kosher species of animal (such as cows and sheep) and milk from a non-kosher species (such as horses, and camels) is forbidden.

In the past it was not uncommon for farmers to mix the milk of their various herds together, unbeknownst to their customers. Since it was conceivable to have a farm selling a mixture of Kosher and non-Kosher milk, Rabbis issued an injunction against the use of milk from a non-Jewish farmer; such milk is referred to as chalav akum. The restriction did not apply if there was supervision of the milking process by a Jew until the milk was sold. The milk itself is automatically kosher (as long as it is 100% from a kosher animal, namely, a cow, sheep, goat, or other kosher mammal) but the Rabbis' decree served to protect people from potential dairy deception.

The first Cholov Yisroel dairy farm on the East Coast, and possibly in the United States, was started by Isaac Balsam in 1903, and remained in business until 1955.

Nowadays, modern health standards (regulated by health organizations, such as the USDA) are intended to make sure that milk sold in stores labeled as “cows' milk” is 100% cows' milk. Therefore, many prominent Orthodox rabbinical authorities, all basing their subsequent decisions on the ruling of Rav Moshe Feinstein, permit the use of regular cows' milk in the United States and other countries with similar regulations when Cholov Yisroel is either not available or priced significantly higher. This is sometimes referred to as cholov stam, meaning “plain milk”. On the other hand, many prominent Orthodox Rabbis actually forbid the use of milk that is not cholov yisroel under any circumstance as violation of a rabbinical prohibition. It was reasoned that if you lived in a remote area, with no real practical way to obtain cholov yisroel milk, and if you needed to consume it for health purposes, then one could reason that “cholov stam” is okay to drink. Today, many rely on this ruling as a way to drink non-cholov yisroel milk and consume cholov stam products (such as M&M candies and Oreo cookies) that are not required for health purposes. Being that there are varying opinions regarding if and when one is permitted to drink “cholov stam”, a competent Rabbi should be consulted.

All dairy products made in the USA or countries where people eat “cholov stam”, even when bearing a Kosher symbol, are most likely to be “cholov stam”. Kosher certifications in such countries usually mark “cholov yisroel” in either English or Hebrew next to their kosher symbol. However, all products certified by the Star-K are Cholov Yisroel. Kosher certification In Israel, kosher certifiers don't usually mark “cholov yisroel” since it is the standard there—in fact, kosher dairy products in Israel that are not Cholov Yisroel need to be marked as such.

Jews who wish to strive for a stricter observance of Jewish law will only consume dairy products that are supervised by a mashgiach and are certified with the label: “Cholov Yisroel”. The retention of the Cholov Yisroel system is also related to the retention of traditions/customs, a central part of Judaism. Kabalistic reasons are also given for being strict concerning cholov yisroel; these are not based on the possibility of mixing non-kosher milk but on spiritual ramifications to drinking non-cholov yisroel.”

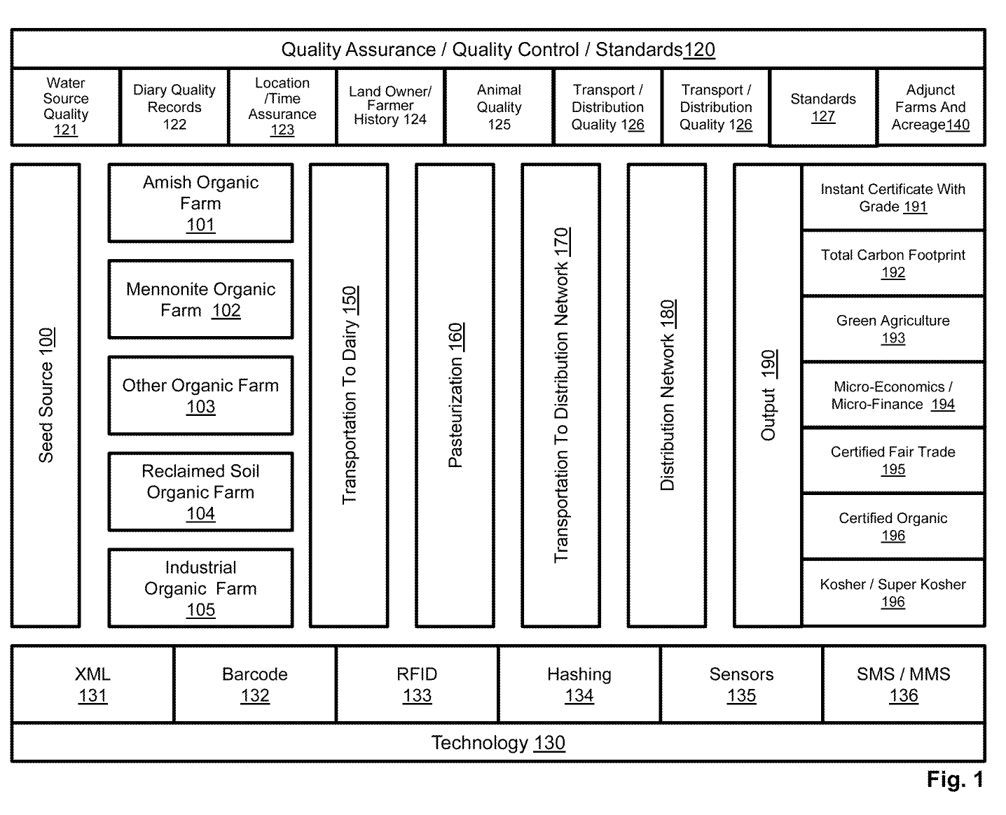

FIG. 1 is a block diagram of various quality, technology, farm, dairy, transportation, and distribution network components that can be used in conjunction with one another in the present invention to provide the necessary information to conform to various standards, or to create certified output statements and documents regarding the quality of the milk or milk derivative products.

The various elements illustrated in FIG. 1 can be used in conjunction with one another to build a system, method, and apparatus that can be used to produce, ship, distribute, and monitor quality of milk and milk derivative products in order to certify to a distributor, and their customer, that they have purchased the highest quality milk or milk derivative products that originated on one of various levels of minimally processed organic farms, which has in turn been pasteurized by the best commercially available method.

Seed source 100. It all starts with the seed. Seed source 100 is a vitally important aspect in achieving the highest quality milk or milk derivative products. Currently, the USDA organic Rule states that “The use of genetically engineered organisms and their products are prohibited in any form or at any stage in minimally processed organic production, processing or handling.” In the future, that may change through the appeals process, and if it does, seed source 100 will be an important factor in determining and reporting the overall quality level to a consumer of a minimally processed organic product. Part of the issue surrounding seed source 100 purity is the problem of genetically modified organism (GMO) contamination on minimally processed organic and non-GMO farms. Also, in the future, the GMO contamination problem may overcome the wide-spread ability for minimally processed organic farms to remain pure from unintentional GMO contamination from nearby farms that use GMO seed. The problem is illustrated in the USDA's stance on genetically modified alfalfa.

The adjunct farms and acreage 140 metric addresses the physical location of an minimally processed organic farm to a GMO farm, and assign a value to the possibility of contamination due to cross-pollination.

The adjunct farms and acreage 140 metric addresses the physical location of non-GMO farms, and assign a value to the possibility of contamination due to run-off, airborne transport, etc, of pesticides and herbicides.

Amish minimally processed organic farm 101. It all starts with the seed, and possibility of contamination from nearby GMO farms. Baring GMO contamination, the next most important aspect in achieving the highest quality milk or milk derivative products is the farm soil. Amish farms by historical practice far exceed the USDA minimally processed organic requirement that a farm seeking the certified minimally processed organic label to be pesticide, and herbicide free for three years. Amish minimally processed organic farms 101 in Iowa are small, have been in the same family for 150 years, and have never been touched by chemical herbicides or pesticides.

Mennonite minimally processed organic farm 102. It all starts with the seed, and possibility of contamination from nearby GMO farms. Baring GMO contamination, the next most important aspect in achieving the highest quality milk or milk derivative products is the farm soil. Mennonite farms by historical practice far exceed the USDA minimally processed organic requirement that a farm seeking the certified minimally processed organic label to be pesticide, and herbicide free for three years. As an example, Mennonite minimally processed organic farms 102 in Iowa are small, have been in the same family for 150 years, and have never been touched by chemical herbicides or pesticides.

Other minimally processed organic farm 103. It all starts with the seed, and possibility of contamination from nearby GMO farms. Baring GMO contamination, the next most important aspect in achieving the highest quality milk or milk derivative products is the farm soil. Other minimally processed organic farms 103 may have been in the same family for an extended period of time, but more likely will have had a history of chemical herbicides or pesticides. The USDA minimally processed organic rule of a minimum of three years of being herbicide and pesticide free is only a starting point as a metric of farm soil quality. As an example, a farm that has been practicing minimally processed organic farming for 30 years, would receive a higher quality than a farm that has just recently transitioned to minimally processed organic farming.

Reclaimed soil minimally processed organic farm 104. It all starts with the seed, and possibility of contamination from nearby GMO farms. Baring GMO contamination, the next most important aspect in achieving the highest quality milk or milk derivative products is the farm soil. A reclaimed soil minimally processed organic farm 104 may have been in the same family for an extended period of time, but more likely will have had a history of chemical herbicides or pesticides. The USDA minimally processed organic rule of a minimum of three years of being herbicide and pesticide free is only a starting point as a metric of farm soil quality. A farm that has actively reclaimed soil that has previously been contaminated with pesticides and herbicides would receive a higher quality grade than a farm (other minimally processed organic farm 103) that has transitioned to minimally processed organic farming via the standard method of allowing the soil to leech out contaminants over a three year period in order to achieve USDA Certified Minimally processed organic Certification.

Industrial minimally processed organic farm 105. It all starts with the seed, and possibility of contamination from nearby GMO farms. Baring GMO contamination, the next most important aspect in achieving the highest quality milk or milk derivative products is the farm soil. It is a common misunderstanding that minimally processed organic farms are small, have been in a family for generations. But many minimally processed organic farms are big, and more industrial in nature and size. Technically, they meet the USDA minimally processed organic rules, but from a practical point of view, larger operations practicing minimally processed organic farming would typically receive a lower overall quality grade than an Amish or Mennonite minimally processed organic farm 101, 102, or a small non-Amish or non-Mennonite farm (other minimally processed organic farm 103).

A good example of the problems created by industrial minimally processed organic farms 105 is the use of non-minimally processed organic substances in minimally processed organic farming. A random example of a synthetic substance approved for use in minimally processed organic farming is Sucrose Octanoate Esters (035300) and Sorbitol Octanoate (035400).

Quality assurance/quality control/standards 120. This element of the present invention incorporates quality metrics including, but not limited to, water source quality 121, dairy quality records 122, location/time assurance 123, land owner/farmer history 124, animal quality 125, and transportation/distribution quality 126. There is nothing that prohibits the requirements of USDA Certified Minimally processed organic Labels can be exceeded, when measured and assessed by the aforementioned quality metrics. The present invention stated goal is to provide a system, method, and apparatus for a non-industrialized, sustainable, minimally processed organic dairy industry that provides the highest quality milk and milk derivative products end-to-end, from ground-to-cow-to-dairy-to-distribution-to-consumer, and is centered on low temperature pasteurization.

As an example, even though the USDA does not allow GMO seed to be used on a Certified Minimally processed organic Farm, it may be that a nearby GMO facility may unintentionally contaminate one, or more nearby USDA Certified Minimally processed organic Farms by cross-pollination. Therefore, a USDA Certified Minimally processed organic Farm that is ten milks from the nearest GMO source, could receive a high rating than a USDA Certified Minimally processed organic Farm that is only three miles from the nearest GMO source.

The National Minimally processed organic Action Plan recommends the adoption of legislation that shifts the responsibility and liability for buffering against GMO contamination to the manufacturers and/or patent-holders of GMO seeds by 2012. NOAP recommendations also include rBGH labeling on all products by 2010 and GMO labeling by 2012 to protect minimally processed organic integrity. This proposed legislation may, or may not, be enacted, therefore, it is important to measure and assess quality metrics that would directly affect the highest quality of minimally processed organically certified sourced milk for use in the present invention's pasteurization process.

Water source quality 121. The water source quality metric 121 assess the quality of the irrigation water, or well water used to grow crops, or water animals that are used to produce the highest quality milk for use in the present invention's pasteurization process. As an example, the water source quality 121 metric might assess water quality factors, such as, but not limited to, pH, ammonia levels, nitrate levels, nitrite, levels, phosphate levels, etc.

Dairy quality records 122. The dairy quality records 122 quality metric measures a particular minimally processed organic farm's dairy quality records. Are they electronic? Does the dairy have frequent violations? Does the dairy have its own quality program that is superior to the minimum standards? As an example, a dairy farm that uses an electronic record keeping system would receive a higher quality score than a dairy farm that doesn't use an electronic record keeping system.

Location/time assurance 123. The location/time assurance 123 metric presumes technology such as, but not limited to, RFID 133, is used to manage a minimally processed organic dairy operation. A dairy farm that uses RFID to log and record locations and times related to their herd management, would receive an overall higher quality score with regard to the location/time assurance metric 123.

Land owner/farmer history 124. The land owner/farm history 124 quality assurance metric will address the history of the farmer and land ownership of an minimally processed organic farm, and assign a value to the longevity factor of ownership, farmer's resume, etc related to minimally processed organic purity.

Animal quality 125. The animal quality 125 quality metric is designed to assess the genetic quality of a particular animal.

Transportation/distribution quality 126. The transportation/distribution quality 126 metric assesses the maintenance and age of dairy's fleet used to transport raw milk, or a fleet used to transport finished milk or milk derivative products to the distribution network's outlets.

Technology 130, this element of the present invention incorporates various technologies that may be employed in accordance with best quality practices to meet the stated goal of the present invention. The present invention stated goal is to provide a system, method, and apparatus for a non-industrialized, sustainable, minimally processed organic dairy industry that provides the highest quality milk and milk derivative products end-to-end from ground-to-cow-to-dairy-to-distribution-to-consumer, and is centered on low temperature pasteurization. The technologies that can be employed in conjunction with the present invention include, but are not limited to XML 131, barcode 132, RFID 133 (Radio Frequency Identification), hashing 134, sensors 135, and SMS 136 (Short Message Service), in order to meet the stated goal of the present invention.

XML 131 (eXtensible Markup Language). XML is extensively used in the world of computing. XML is a set of rules for encoding documents electronically. It is defined in the XML 1.0 Specification produced by the W3C and several other related specifications, which are fee-free open standards.

XML's design goals emphasize simplicity, generality, and usability over the Internet. It is a textual data format, with strong support via Unicode for the languages of the world. Although XML's design focuses on documents, it is widely used for the representation of arbitrary data structures, for example in web services.

There are many programming interfaces that software developers may use to access XML data, and several schema systems designed to aid in the definition of XML-based languages.

In a web-service quality system employed in support of the stated goal of the present invention, XML would be used as a means of generating standardized documents that can be exchanged, and used to enter and retrieve data from back-end systems.

The key to XML for any specific purpose is the development of an accepted schema for a particular application. In the present invention, a minimally processed organic Dairy XML Schema may be developed to describe all aspects of the business process model for ground-to-cow-to-dairy-to-distribution-to-consumer.

In addition to XML as a ubiquitous data presentation and interchange technology is the whole concept of cascading style sheets. Cascading style sheets (CSS) is a style sheet language used to describe the presentation semantics (that is, the look and formatting) of a document written in a markup language. It's most common application is to style web pages written in HTML and XHTML, but the language can also be applied to any kind of XML document, including SVG and XUL.

CSS is designed primarily to enable the separation of document content (written in HTML or a similar markup language) from document presentation, including elements such as the layout, colors, and fonts. This separation can improve content accessibility, provide more flexibility and control in the specification of presentation characteristics, enable multiple pages to share formatting, and reduce complexity and repetition in the structural content (such as by allowing for table-less web design). CSS can also allow the same markup page to be presented in different styles for different rendering methods, such as on-screen, in print, by voice when read out by a speech-based browser or screen reader, and on Braille-based, tactile devices. While the author of a document typically links that document to a CSS style sheet, readers can use a different style sheet, perhaps one on their own computer, to override the one the author has specified.

CSS specifies a priority scheme to determine which style rules apply if more than one rule matches against a particular element. In this so-called cascade, priorities or weights are calculated and assigned to rules, so that the results are predictable.

The CSS specifications are maintained by the World Wide Web Consortium (W3C). Internet media type (MIME type) text/css is registered for use with CSS by RFC 2318 (March 1998).

The main point of discussing CSS is that it is a ubiquitous technology that can be employed in conjunction with the present invention to provide a unique method of displaying quality records, consumer information, etc that use XML, RFID information, barcode information, etc.

Barcode 132. A barcode is an optical machine-readable representation of data, which shows certain data on certain products. Originally, barcodes represented data in the widths (lines) and the spacing of parallel lines, and may be referred to as linear or 1D (1 dimensional) barcodes or symbologies. They also come in patterns of squares, dots, hexagons and other geometric patterns within images termed 2D (2 dimensional) matrix codes or symbologies. Although 2D systems use symbols other than bars, they are generally referred to as barcodes as well. Barcodes can be read by optical scanners called barcode readers, or scanned from an image by special software. The barcodes for use in conjunction with the present invention may be printed or video displayed.

RFID 133. Radio-frequency identification (RFID) is the use of an object (typically referred to as an RFID tag) applied to or incorporated into a product, animal, or person for the purpose of identification and tracking using radio waves. Some tags can be read from several meters away and beyond the line of sight of the reader.

Radio-frequency identification comprises interrogators (also known as readers), and tags (also known as labels).

Most RFID tags contain at least two parts. One is an integrated circuit for storing and processing information, modulating and demodulating a radio-frequency (RF) signal, and other specialized functions. The second is an antenna for receiving and transmitting the signal.

There are generally three types of RFID tags: active RFID tags, which contain a battery and can transmit signals autonomously, passive RFID tags, which have no battery and require an external source to provoke signal transmission, and battery assisted passive (BAP) RFID tags, which require an external source to wake up but have significant higher forward link capability providing greater range.

There are a variety of groups defining standards and regulating the use of RFID, including: International Organization for Standardization (ISO), International Electrotechnical Commission (IEC), ASTM International, DASH7 Alliance, EPCglobal. (Refer to Regulation and Standardization Below.)

RFID has many applications; for example, it is used in enterprise supply chain management to improve the efficiency of inventory tracking and management.

Barcode 132 and RFID 133 technologies can both use the EPCglobal standards for identification. In addition, the EPCglobal Gen 2 standard defines RFID reader hardware and tag standards for interoperability. In addition to the ubiquitous nature of barcodes and RFID tags that conform to the EPCglobal standard, tags can be created that include a free-form customizable area that a vendor can use for purposes other than product or company identification, such as information and data used in the conjunction with the present invention.

Hashing 134. A hash function is any well-defined procedure or mathematical function that converts a large, possibly variable-sized amount of data into a small datum, usually a single integer that may serve as an index to an array. The values returned by a hash function are called hash values, hash codes, hash sums, checksums or simply hashes.

Hash functions are mostly used to speed up table lookup or data comparison tasks—such as finding items in a database, detecting duplicated or similar records in a large file, finding similar stretches in DNA sequences, and so on.

A hash function may map two or more keys to the same hash value. In many applications, it is desirable to minimize the occurrence of such collisions, which means that the hash function must map the keys to the hash values as evenly as possible. Depending on the application, other properties may be required as well. Although the idea was conceived in the 1950s, the design of good hash functions is still a topic of active research.

Hash functions are related to (and often confused with) checksums, check digits, fingerprints, randomization functions, error correcting codes, and cryptographic hash functions. Although these concepts overlap to some extent, each has its own uses and requirements and is designed and optimized differently. The HashKeeper database maintained by the American National Drug Intelligence Center, for instance, is more aptly described as a catalog of file fingerprints than of hash values.

As an example, hashed data can be used as an analysis tool for comparing and categorizing data related to overall quality of dairy products produced in accordance with the present invention.

The present invention defines a hash function as a data comparison tool, a look-up tool, a checksum, a check digit, a fingerprint, a randomization function, an error correcting code, and a cryptographic hash.

Sensors 135. A sensor is a device that measures a physical quantity and converts it into a signal which can be read by an observer or by an instrument. For example, a mercury-in-glass thermometer converts the measured temperature into expansion and contraction of a liquid which can be read on a calibrated glass tube. A thermocouple converts temperature to an output voltage which can be read by a voltmeter. For accuracy, all sensors need to be calibrated against known standards.

Sensors can be used at the farm on animals, on the farm, during the transportation of the raw product, in the dairy process, in the transportation process to the retail outlets, and in the retail outlet. The sensors can be acquiring data such as, but not limited to, location, temperature, time, as input to drive the quality record for raw and processed dairy products.

SMS 136. Short Message Service (SMS) is a communication service component of the GSM mobile communication system, using standardized communications protocols that allow the exchange of short text messages between mobile phone devices. SMS text messaging is the most widely used data application in the world, with 2.4 billion active users, or 74% of all mobile phone subscribers. The term SMS is used as a synonym for all types of short text messaging, as well as the user activity itself, in many parts of the world.

SMS as used on modern handsets was originally defined as part of the Global System for Mobile Communications (GSM) series of standards in 1985 as a means of sending messages of up to 160 characters, to and from GSM mobile handsets. Since then, support for the service has expanded to include other mobile technologies such as ANSI CDMA networks and Digital AMPS, as well as satellite and landline networks. Most SMS messages are mobile-to-mobile text messages, though the standard supports other types of broadcast messaging as well.

In the present invention, SMS also is defined as Multimedia Messaging Service, or MMS, is a standard way to send messages that include multimedia content to and from mobile phones. It extends the core SMS (Short Message Service) capability which only allowed exchange of text messages up to 160 characters in length.

The most popular use is to send photographs from camera-equipped handsets, although it is also popular as a method of delivering news and entertainment content including videos, pictures, text pages and ring tones.

The standard is developed by the Open Mobile Alliance (OMA), although during development it was part of the 3GPP and WAP groups.

Transportation to dairy 150. In this step of the process, raw milk is transported from the farm to the dairy for processing. The transportation to dairy 160 may employ the use of sensors 135 to automatically collect information related to quality such as, but not limited to, pick-up and delivery times, location, temperatures of the raw milk, etc. This data may also be collected using RFID 133 or barcode 132 tags, or be input by hand on a log sheet, or input directly into a laptop, smartphone, etc, or not collected at all.

Pasteurization 160. In the preferred embodiment of the present invention is vat pasteurized at 145 degrees Fahrenheit. For at least 30 minutes. The vat pasteurized milk is stored into holding tanks as skimmed or whole milk. Then in a unique method it is blended as required to complete a specific bottling order. Whole milk is drawn from the whole milk holding tank, skim milk is drawn from a skimmed milk holding tank, 1% and 2% milk are blended in the appropriate volumes from milk stored in both the skimmed and whole milk tanks. Milk that is minimally processed is not homogenized.

In other embodiments of the present invention, the raw milk can be pasteurized using less acceptable, though widely used and approved methods, such as, but not limited to HTST (High Temperature/Short Time), UHT (Ultra High Temperature), cold pasteurization (which is an irradiation process), etc. The standards for pasteurization may vary from country to country.

Transportation to distribution network 170. In this step of the process, processed milk, or milk products, are transported from the farm to the dairy for processing. The transportation to distribution network 170 may employ the use of sensors 135 to automatically collect information related to quality such as, but not limited to, pick-up and delivery times, location, temperatures of the processed milk, or milk products, etc. This data may also be collected using RFID 133 or barcode 132 tags, or be input by hand on a log sheet, or input directly into a laptop, smartphone, etc, or not collected at all.

Distribution network 180. In this step of the process, processed milk, or milk products, reside in retail outlets for sale to a consumer or business. The distribution network 180 may employ the use of sensors 135 to automatically collect information related to quality such as, but not limited to, pick-up and delivery times, location, temperatures of the processed milk, or milk products, etc. This data may also be collected using RFID 133 or barcode 132 tags, or be input by hand on a log sheet, or input directly into a laptop, smartphone, etc, or not collected at all.

Output 190 includes items such as, but not limited to, instant certificate with grade 19, total carbon footprint 192 number, green agriculture 193 statement, micro-economics or micro-finance 194 statement, certified fair trade 195 statement, certified minimally processed organic 196 statement for farm and/or dairy, kosher or super kosher 197 statement. Super kosher is a term used interchangeably in this patent with Cholov Kosher.

Output 190 can be provided on request to a distribution network 180, a consumer or business that is purchasing milk, or milk products, a governmental agency, an insurance company, etc. The output can be generated as an instant certification, which includes a numerical grade and/or a corresponding color code using technology such as, but not limited to XML and CSS, and displayed on a video display operating on a laptop, net book, notebook, iPAD, smart phone, etc.

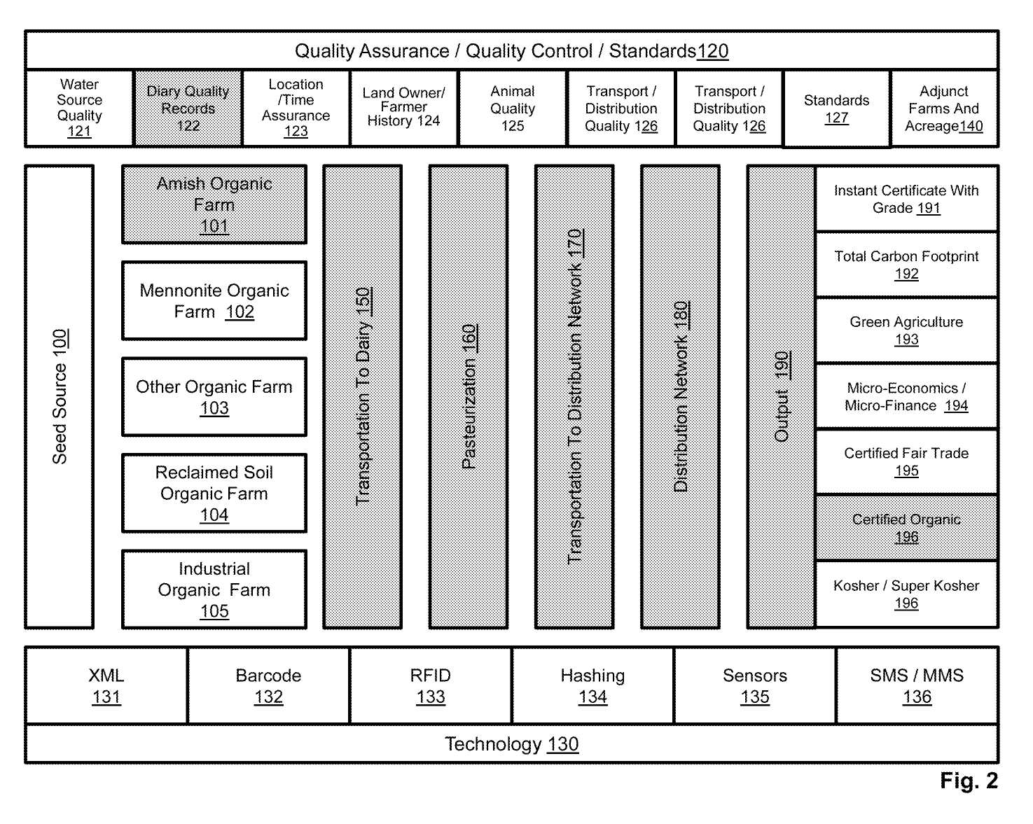

FIG. 2 is a block diagram of the quality, technology, farm, dairy, transportation, and distribution network components that were selected for use in a minimal state of compliance in accordance with the present invention.

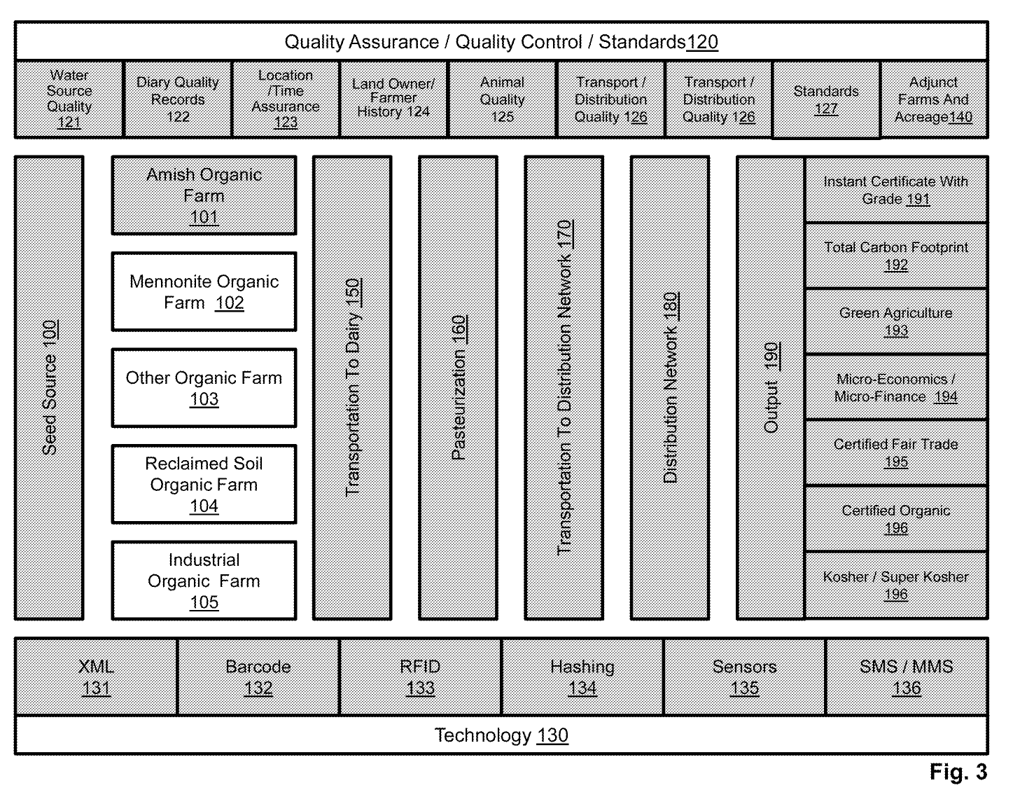

FIG. 3 is a block diagram of the quality, technology, farm, dairy, transportation, and distribution network components that were selected for use in a maximal state of compliance in accordance with the present invention.

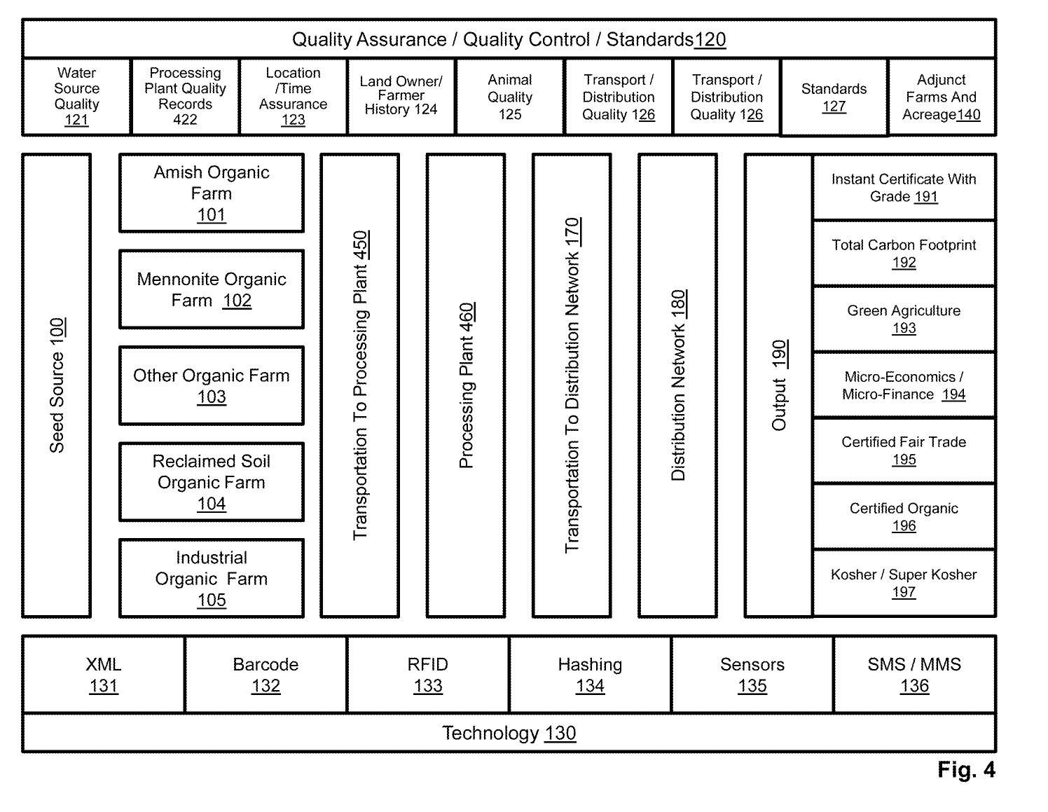

FIG. 4 is a block diagram of various quality, technology, non-dairy farm that produces agricultural products, such as, but not limited to, meats, fowl, fish, vegetables, nuts, fruits, eggs etc, processing plant, transportation, and distribution network components that can be used in conjunction with one another in the present invention to provide the necessary information to conform to various standards, or to create certified output statements and documents regarding the quality of the agricultural non-dairy products.

The various elements illustrated in FIG. 4 can be used in conjunction with one another to build a system, method, and apparatus that can be used to produce, ship, distribute, and monitor agricultural products in order to certify to a distributor, and their customer, that they have purchased the highest quality agricultural non-dairy products that originated on one of various levels of minimally processed organic farms, which has in turn been minimally processed by the best commercially available method.

Seed source 100. It all starts with the seed. Seed source 100 is a vitally important aspect in achieving the highest quality non-dairy agricultural products. Currently, the USDA Minimally processed organic Rule states that “The use of genetically engineered organisms and their products are prohibited in any form or at any stage in minimally processed organic production, processing or handling.” In the future, that may change through the appeals process, and if it does, seed source 100 will be an important factor in determining and reporting the overall quality level to a consumer of an minimally processed organic product. Part of the issue surrounding seed source 100 purity is the problem of genetically modified organism (GMO) contamination on minimally processed organic and non-GMO farms. Also, in the future, the GMO contamination problem may overcome the wide-spread ability for minimally processed organic farms to remain pure from unintentional GMO contamination from nearby farms that use GMO seed. The problem is illustrated in the USDA's stance on genetically modified alfalfa.

The adjunct farms and acreage 140 metric addresses the physical location of an minimally processed organic farm to a GMO farm, and assign a value to the possibility of contamination due to cross-pollination.

The adjunct farms and acreage 140 metric addresses the physical location of non-GMO farms, and assign a value to the possibility of contamination due to run-off, airborne transport, etc, of pesticides and herbicides.

Amish minimally processed organic farm 101. It all starts with the seed, and possibility of contamination from nearby GMO farms. Baring GMO contamination, the next most important aspect in achieving the highest quality non-dairy agricultural products is the farm soil. Amish farms by historical practice far exceed the USDA minimally processed organic requirement that a farm seeking the certified minimally processed organic label to be pesticide, and herbicide free for three years. Amish minimally processed organic farms 101 in Iowa are small, have been in the same family for 150 years, and have never been touched by chemical herbicides or pesticides.

Mennonite minimally processed organic farm 102. It all starts with the seed, and possibility of contamination from nearby GMO farms. Baring GMO contamination, the next most important aspect in achieving the highest quality non-dairy agricultural products is the farm soil. Mennonite farms by historical practice far exceed the USDA minimally processed organic requirement that a farm seeking the certified minimally processed organic label to be pesticide, and herbicide free for three years. Mennonite minimally processed organic farms 102 in Iowa are small, have been in the same family for 150 years, and have never been touched by chemical herbicides or pesticides.

Other minimally processed organic farm 103. It all starts with the seed, and possibility of contamination from nearby GMO farms. Baring GMO contamination, the next most important aspect in achieving the highest quality non-dairy agricultural products is the farm soil. Other minimally processed organic farms 103 may have been in the same family for an extended period of time, but more likely will have had a history of chemical herbicides or pesticides. The USDA minimally processed organic rule of a minimum of three years of being herbicide and pesticide free is only a starting point as a metric of farm soil quality. As an example, a farm that has been practicing minimally processed organic farming for 30 years, would receive a higher quality than a farm that has just recently transitioned to minimally processed organic farming.

Reclaimed soil minimally processed organic farm 104. It all starts with the seed, and possibility of contamination from nearby GMO farms. Baring GMO contamination, the next most important aspect in achieving the highest quality non-dairy agricultural products is the farm soil. A reclaimed soil minimally processed organic farm 104 may have been in the same family for an extended period of time, but more likely will have had a history of chemical herbicides or pesticides. The USDA minimally processed organic rule of a minimum of three years of being herbicide and pesticide free is only a starting point as a metric of farm soil quality. A farm that has actively reclaimed soil that has previously been contaminated with pesticides and herbicides would receive a higher quality grade than a farm (other minimally processed organic farm 103) that has transitioned to minimally processed organic farming via the standard method of allowing the soil to leech out contaminants over a three year period in order to achieve USDA Certified Minimally processed organic Certification.

Industrial minimally processed organic farm 105. It all starts with the seed, and possibility of contamination from nearby GMO farms. Baring GMO contamination, the next most important aspect in achieving the highest quality non-dairy agricultural products is the farm soil. It is a common misunderstanding that minimally processed organic farms are small, have been in a family for generations. But many minimally processed organic farms are big, and more industrial in nature and size. Technically, they meet the USDA minimally processed organic rules, but from a practical point of view, larger operations practicing minimally processed organic farming would typically receive a lower overall quality grade than an Amish or Mennonite minimally processed organic farm 101, 102, or a small non-Amish or non-Mennonite farm, such as, but not limited to, other minimally processed organic farm 103.

A good example of the problems created by industrial minimally processed organic farms 105 is the use of non-minimally processed organic substances in minimally processed organic farming. A random example of a synthetic substance approved for use in minimally processed organic farming is Sucrose Octanoate Esters (035300) and Sorbitol Octanoate (035400).

Quality assurance/quality control/standards 120. This element of the present invention incorporates quality metrics including, but not limited to, water source quality 121, processing plant quality records 422, location/time assurance 123, land owner/farmer history 124, animal quality 125, and transportation/distribution quality 126. There is nothing that prohibits the requirements of USDA Certified Minimally processed organic Labels can be exceeded, when measured and assessed by the aforementioned quality metrics. The present invention stated goal is to provide a system, method, and apparatus for a non-industrialized, sustainable, minimally processed organic non-dairy industry that provides the highest quality milk and milk derivative products end-to-end from ground-to-processing plant-to-distribution-to-consumer, and is centered on low temperature pasteurization.

As an example, even though the USDA does not allow GMO seed to be used on a Certified Minimally processed organic Farm, it may be that a nearby GMO facility may unintentionally contaminate one, or more nearby USDA Certified Minimally processed organic Farms by cross-pollination. Therefore, a USDA Certified Minimally processed organic Farm that is ten milks from the nearest GMO source could receive a high rating than a USDA Certified Minimally processed organic Farm that is only three miles from the nearest GMO source.

The National Minimally processed organic Action Plan recommends the adoption of legislation that shifts the responsibility and liability for buffering against GMO contamination to the manufacturers and/or patent-holders of GMO seeds by 2012. NOAP recommendations also include rBGH labeling on all products by 2010 and GMO labeling by 2012 to protect minimally processed organic integrity. This proposed legislation may, or may not, be enacted, therefore, it is important to measure and assess quality metrics that would directly affect the highest quality of minimally processed organically certified sourced agricultural products.

Water source quality 121. The water source quality metric 121 assess the quality of the irrigation water, or well water used to grow crops, or water animals that are used to produce the quality non-dairy agricultural products for use in the present invention's pasteurization process. As an example, the water source quality 121 metric might assess water quality factors, such as, but not limited to, pH, ammonia levels, nitrate levels, nitrite, levels, phosphate levels, etc.

Processing plant quality records 422. The processing plant quality records 422 quality metric measures a particular minimally processed organic farm's quality records. Are they electronic? Does the processing plant have frequent violations? Does the processing plant have its own quality program that is superior to the minimum standards? As an example, a farm that uses an electronic record keeping system would receive a higher quality score than a farm that doesn't use an electronic record keeping system.

Location/time assurance 123. The location/time assurance 123 metric presumes technology such as, but not limited to, RFID 133, is used to manage an minimally processed organic non-dairy operation. A non-dairy farm that uses RFID to log and record locations and times related to their herd management, would receive an overall higher quality score with regard to the location/time assurance metric 123.

Land owner/farmer history 124. The land owner/farm history 124 quality assurance metric will address the history of the farmer and land ownership of an minimally processed organic farm, and assign a value to the longevity factor of ownership, farmer's resume, etc related to minimally processed organic purity.

Animal quality 125. The animal quality 125 quality metric is designed to assess the genetic quality of a particular animal that is being raised for slaughter.

Transportation/distribution quality 126. The transportation/distribution quality 126 metric assesses the maintenance and age of the fleet used to transport agricultural product, or a fleet used to transport finished non-dairy agricultural products to the distribution network's outlets.

Technology 130, this element of the present invention incorporates various technologies that may be employed in accordance with best quality practices to meet the stated goal of the present invention. The present invention stated goal is to provide a system, method, and apparatus for a non-industrialized, sustainable, minimally processed organic non-dairy industry that provides the highest quality non-dairy agricultural products end-to-end from ground-to-processing plant-to-distribution-to-consumer. The technologies that can be employed in conjunction with the present invention include, but are not limited to XML 131, barcode 132, RFID 133 (Radio Frequency Identification), hashing 134, sensors 135, and SMS 136 (Short Message Service), in order to meet the stated goal of the present invention.

XML 131 (eXtensible Markup Language). XML is extensively used in the world of computing. XML is a set of rules for encoding documents electronically. It is defined in the XML 1.0 Specification produced by the W3C and several other related specifications, which are fee-free open standards.

XML's design goals emphasize simplicity, generality, and usability over the Internet. It is a textual data format, with strong support via Unicode for the languages of the world. Although XML's design focuses on documents, it is widely used for the representation of arbitrary data structures, for example in web services.

There are many programming interfaces that software developers may use to access XML data, and several schema systems designed to aid in the definition of XML-based languages.

In a web-service quality system employed in support of the stated goal of the present invention, XML would be used as a means of generating standardized documents that can be exchanged, and used to enter and retrieve data from back-end systems.

The key to XML for any specific purpose is the development of an accepted schema for a particular application. In the present invention, a minimally processed organic Non-Dairy Agricultural XML Schema may be developed to describe all aspects of the business process model for ground-to-processing plant-to-distribution-to-consumer.

In addition to XML as a ubiquitous data presentation and interchange technology is the whole concept of cascading style sheets. Cascading style sheets (CSS) is a style sheet language used to describe the presentation semantics (that is, the look and formatting) of a document written in a markup language. It's most common application is to style web pages written in HTML and XHTML, but the language can also be applied to any kind of XML document, including SVG and XUL.

CSS is designed primarily to enable the separation of document content (written in HTML or a similar markup language) from document presentation, including elements such as the layout, colors, and fonts. This separation can improve content accessibility, provide more flexibility and control in the specification of presentation characteristics, enable multiple pages to share formatting, and reduce complexity and repetition in the structural content (such as by allowing for table-less web design). CSS can also allow the same markup page to be presented in different styles for different rendering methods, such as on-screen, in print, by voice when read out by a speech-based browser or screen reader, and on Braille-based, tactile devices. While the author of a document typically links that document to a CSS style sheet, readers can use a different style sheet, perhaps one on their own computer, to override the one the author has specified.

CSS specifies a priority scheme to determine which style rules apply if more than one rule matches against a particular element. In this so-called cascade, priorities or weights are calculated and assigned to rules, so that the results are predictable.

The CSS specifications are maintained by the World Wide Web Consortium (W3C). Internet media type (MIME type) text/css is registered for use with CSS by RFC 2318 (March 1998).

The main point of discussing CSS is that it is a ubiquitous technology that can be employed in conjunction with the present invention to provide a unique method of displaying quality records, consumer information, etc that use XML, RFID information, barcode information, etc.

Barcode 132. A barcode is an optical machine-readable representation of data, which shows certain data on certain products. Originally, barcodes represented data in the widths (lines) and the spacing of parallel lines, and may be referred to as linear or 1D (1 dimensional) barcodes or symbologies. They also come in patterns of squares, dots, hexagons and other geometric patterns within images termed 2D (2 dimensional) matrix codes or symbologies. Although 2D systems use symbols other than bars, they are generally referred to as barcodes as well. Barcodes can be read by optical scanners called barcode readers, or scanned from an image by special software. The barcodes for use in conjunction with the present invention may be printed or video displayed.

RFID 133. Radio-frequency identification (RFID) is the use of an object (typically referred to as an RFID tag) applied to or incorporated into a product, animal, or person for the purpose of identification and tracking using radio waves. Some tags can be read from several meters away and beyond the line of sight of the reader.

Radio-frequency identification comprises interrogators (also known as readers), and tags (also known as labels).

Most RFID tags contain at least two parts. One is an integrated circuit for storing and processing information, modulating and demodulating a radio-frequency (RF) signal, and other specialized functions. The second is an antenna for receiving and transmitting the signal.

There are generally three types of RFID tags: active RFID tags, which contain a battery and can transmit signals autonomously, passive RFID tags, which have no battery and require an external source to provoke signal transmission, and battery assisted passive (BAP) RFID tags, which require an external source to wake up but have significant higher forward link capability providing greater range.

There are a variety of groups defining standards and regulating the use of RFID, including: International Organization for Standardization (ISO), International Electrotechnical Commission (IEC), ASTM International, DASH7 Alliance, EPCglobal. (Refer to Regulation and Standardization Below.)

RFID has many applications; for example, it is used in enterprise supply chain management to improve the efficiency of inventory tracking and management.

Barcode 132 and RFID 133 technologies can both use the EPCglobal standards for identification. In addition, the EPCglobal Gen 2 standard defines RFID reader hardware and tag standards for interoperability. In addition to the ubiquitous nature of barcodes and RFID tags that conform to the EPCglobal standard, tags can be created that include a free-form customizable area that a vendor can use for purposes other than product or company identification, such as information and data used in the conjunction with the present invention.

Hashing 134. A hash function is any well-defined procedure or mathematical function that converts a large, possibly variable-sized amount of data into a small datum, usually a single integer that may serve as an index to an array. The values returned by a hash function are called hash values, hash codes, hash sums, checksums or simply hashes.

Hash functions are mostly used to speed up table lookup or data comparison tasks—such as finding items in a database, detecting duplicated or similar records in a large file, finding similar stretches in DNA sequences, and so on.

A hash function may map two or more keys to the same hash value. In many applications, it is desirable to minimize the occurrence of such collisions, which means that the hash function must map the keys to the hash values as evenly as possible. Depending on the application, other properties may be required as well. Although the idea was conceived in the 1950s, the design of good hash functions is still a topic of active research.

Hash functions are related to (and often confused with) checksums, check digits, fingerprints, randomization functions, error correcting codes, and cryptographic hash functions. Although these concepts overlap to some extent, each has its own uses and requirements and is designed and optimized differently. The HashKeeper database maintained by the American National Drug Intelligence Center, for instance, is more aptly described as a catalog of file fingerprints than of hash values.

As an example, hashed data can be used as an analysis tool for comparing and categorizing data related to overall quality of non-dairy products produced in accordance with the present invention.

The present invention defines a hash function as a data comparison tool, a look-up tool, a checksum, a check digit, a fingerprint, a randomization function, an error correcting code, and a cryptographic hash.

Sensors 135. A sensor is a device that measures a physical quantity and converts it into a signal which can be read by an observer or by an instrument. For example, a mercury-in-glass thermometer converts the measured temperature into expansion and contraction of a liquid which can be read on a calibrated glass tube. A thermocouple converts temperature to an output voltage which can be read by a voltmeter. For accuracy, all sensors need to be calibrated against known standards.

Sensors can be used at the farm on animals, on the farm, during the transportation of the raw product, in the processing plant, in the transportation process to the retail outlets, and in the retail outlet. The sensors can be acquiring data such as, but not limited to, location, temperature, time, as input to drive the quality record for non-dairy agricultural products.

SMS 136. Short Message Service (SMS) is a communication service component of the GSM mobile communication system, using standardized communications protocols that allow the exchange of short text messages between mobile phone devices. SMS text messaging is the most widely used data application in the world, with 2.4 billion active users, or 74% of all mobile phone subscribers. The term SMS is used as a synonym for all types of short text messaging, as well as the user activity itself, in many parts of the world.

SMS as used on modern handsets was originally defined as part of the Global System for Mobile Communications (GSM) series of standards in 1985 as a means of sending messages of up to 160 characters, to and from GSM mobile handsets. Since then, support for the service has expanded to include other mobile technologies such as ANSI CDMA networks and Digital AMPS, as well as satellite and landline networks. Most SMS messages are mobile-to-mobile text messages, though the standard supports other types of broadcast messaging as well.

In the present invention, SMS also is defined as Multimedia Messaging Service, or MMS, is a standard way to send messages that include multimedia content to and from mobile phones. It extends the core SMS (Short Message Service) capability which only allowed exchange of text messages up to 160 characters in length.

The most popular use is to send photographs from camera-equipped handsets, although it is also popular as a method of delivering news and entertainment content including videos, pictures, text pages and ring tones.

The standard is developed by the Open Mobile Alliance (OMA), although during development it was part of the 3GPP and WAP groups.

Transportation to processing plant 450. In this step of the process, agricultural product is transported from the farm to the processing plant for processing. The transportation to processing plant 160 may employ the use of sensors 135 to automatically collect information related to quality such as, but not limited to, pick-up and delivery times, location, temperatures, etc. This data may also be collected using RFID 133 or barcode 132 tags, or be input by hand on a log sheet, or input directly into a laptop, smartphone, etc, or not collected at all.

Processing plant 460. In this step of the process, non-diary agricultural product is transported from the farm to the processing plant for processing. The transportation to processing plant 460 may employ the use of sensors 135 to automatically collect information related to quality such as, but not limited to, pick-up and delivery times, location, temperatures of the raw milk, etc. This data may also be collected using RFID 133 or barcode 132 tags, or be input by hand on a log sheet, or input directly into a laptop, smartphone, etc, or not collected at all.

Transportation to distribution network 170. In this step of the process, processed agricultural products are transported from the farm to the processing plant for processing. The transportation to distribution network 170 may employ the use of sensors 135 to automatically collect information related to quality such as, but not limited to, pick-up and delivery times, location, temperatures of non-dairy agricultural products, etc. This data may also be collected using RFID 133 or barcode 132 tags, or be input by hand on a log sheet, or input directly into a laptop, smartphone, etc, or not collected at all.

Distribution network 180. In this step of the process, non-dairy agricultural products, reside in retail outlets for sale to a consumer or business. The distribution network 180 may employ the use of sensors 135 to automatically collect information related to quality such as, but not limited to, pick-up and delivery times, location, temperatures of the processed milk, or milk products, etc. This data may also be collected using RFID 133 or barcode 132 tags, or be input by hand on a log sheet, or input directly into a laptop, smartphone, etc, or not collected at all.

Output 190 includes items such as, but not limited to, instant certificate with grade 19, total carbon footprint 192 number, green agriculture 193 statement, micro-economics or micro-finance 194 statement, certified fair trade 195 statement, certified minimally processed organic 196 statement for farm and/or dairy, kosher or super kosher 197 statement. Super kosher is a term used interchangeably in this patent with Cholov Kosher.

Output 190 can be provided on request to a distribution network 180, a consumer or business that is purchasing milk, or milk products, a governmental agency, an insurance company, etc. The output can be generated using technology such as, but not limited to XML and CSS, and displayed on a video display operating on a laptop, net book, notebook, iPAD, smart phone, etc.

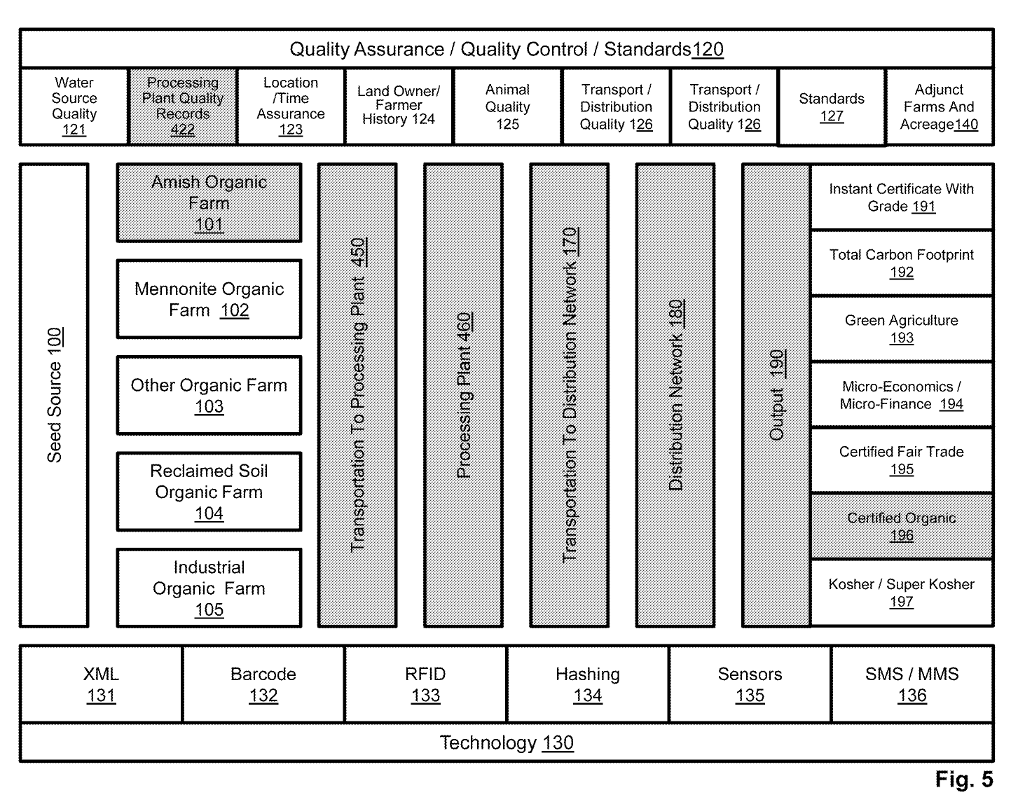

FIG. 5 is a block diagram of the quality, technology, farm, processing plant, transportation, and distribution network components that were selected for use in a minimal state of compliance in accordance with the present invention.

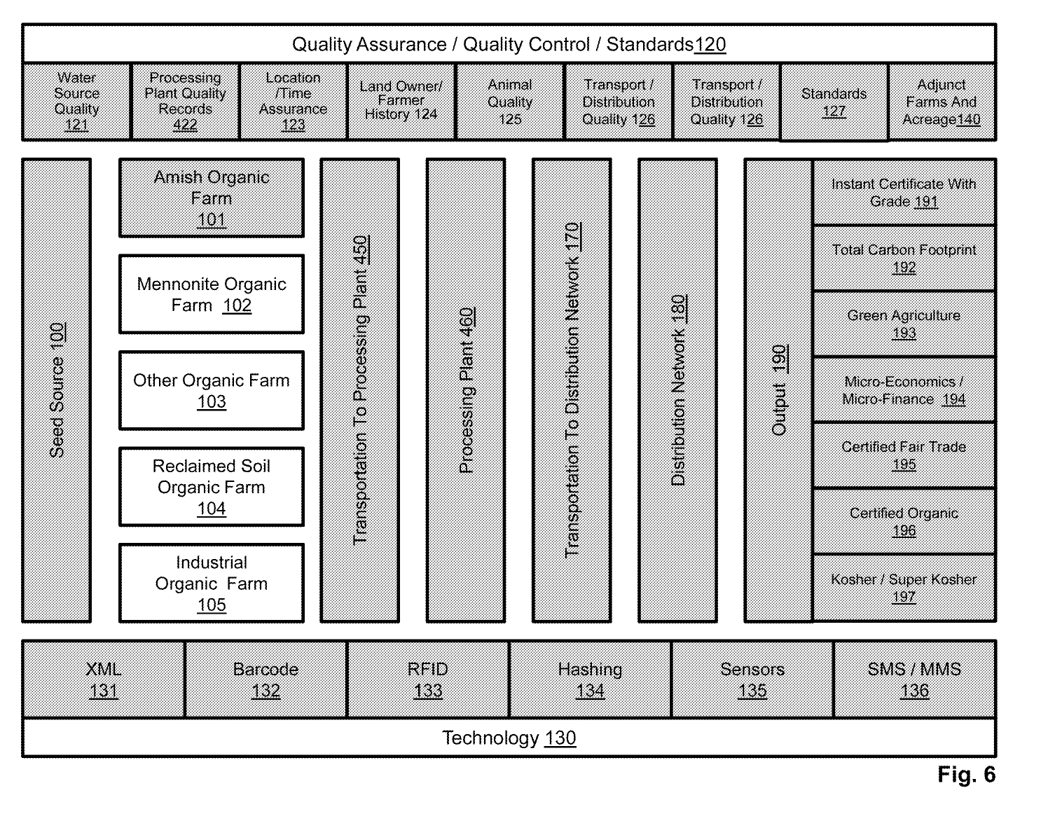

FIG. 6 is a block diagram of the quality, technology, farm, processing plant, transportation, and distribution network components that were selected for use in a maximal state of compliance in accordance with the present invention.

CHART 1
DAIRY PRODUCT QUALITY INPUTS

| | | | | BEST | FAIR | WORST |
|---|---|---|---|---|---|---|
| QUALITY | QUALITY | QUALITY | POSSIBLE | SCORE | SCORE | SCORE |
| ITEM 1 | ITEM 2 | ITEM 3 | POINTS | (GREEN) | (YELLOW) | (RED) |
| FARM | SEED SOURCE | MINIMALLY | 50 | 50 | 50 | |
| | | PROCESSED | | | | |
| | | ORGANIC | | | | |
| FARM | SEED SOURCE | HYBRID | −50 | | | −50 |
| FARM | GROUND | AMISH | 500 | 500 | | |
| FARM | GROUND | MENNONITE | 500 | | | |
| FARM | GROUND | MINIMALLY | 250 | | 250 | |
| | | PROCESSED | | | | |
| | | ORGANIC | | | | |
| FARM | GROUND | RECLAIMED | 0 | | | |
| | | SOIL | | | | |
| | | MINIMALLY | | | | |
| | | PROCESSED | | | | |
| | | ORGANIC | | | | |
| FARM | GROUND | INDUSTRIAL | −100 | | | |
| | | MINIMALLY | | | | |
| | | PROCESSED | | | | |
| | | ORGANIC | | | | |
| FARM | GROUND | NON- | −250 | | | −250 |
| | | MINIMALLY | | | | |
| | | PROCESSED | | | | |
| | | ORGANIC | | | | |
| FARM | WATER SOURCE | LOW | −100 | | | −100 |
| | QUALITY | | | | | |
| FARM | WATER SOURCE | MEDIUM | 0 | | | |
| | QUALITY | | | | | |
| FARM | WATER SOURCE | HIGH | 100 | 100 | 100 | |
| | QUALITY | | | | | |
| FARM | ANIMAL | LOW | −50 | | | −50 |
| | GENETICS | | | | | |
| FARM | ANIMAL | MEDIUM | 0 | | | |
| | GENETICS | | | | | |
| FARM | ANIMAL | HIGH | 50 | 50 | 50 | |
| | GENETICS | | | | | |
| FARM | ANIMAL STRESS | LOW | 100 | 100 | 100 | |
| | LEVEL | | | | | |
| FARM | ANIMAL STRESS | MEDIUM | 0 | | | |
| | LEVEL | | | | | |
| FARM | ANIMAL STRESS | HIGH | −100 | | | −100 |
| | LEVEL | | | | | |
| FARM | ANIMAL | NO | 0 | | | 0 |
| | LOCATION | | | | | |
| | TRACKED | | | | | |
| FARM | ANIMAL | YES | 50 | 50 | 50 | |
| | LOCATION | | | | | |
| | TRACKED | | | | | |
| FARM | MEETS | NO | −250 | | | −250 |
| | STANDARDS | | | | | |
| | CONSISTENTLY | | | | | |
| FARM | MEETS | YES | 250 | 250 | 250 | |
| | STANDARDS | | | | | |
| | CONSISTENTLY | | | | | |
| FARM SUB-TOTAL | | | | 1100 | 850 | −800 |
| TRANSPORTATION- | HAUL DISTANCE | SHORT | 50 | 50 | | |
| TO DAIRY | | | | | | |
| TRANSPORTATION | HAUL DISTANCE | MEDIUM | 0 | | 0 | |
| TO DAIRY | | | | | | |
| TRANSPORTATION | HAUL DISTANCE | LONG | −50 | | | |
| TO DAIRY | | | | | | |
| TRANSPORTATION | TRUCK | \NO | −50 | | | |
| TO DAIRY | LOCATION | | | | | |
| | TRACKED | | | | | |
| TRANSPORTATION | TRUCK | YES | 50 | 50 | 50 | |
| TO DAIRY | LOCATION | | | | | |
| | TRACKED | | | | | |
| TRANSPORTATION | SENSORS | NO | −10 | | | |
| TO DAIRY | | | | | | |
| TRANSPORTATION | SENSORS | YES | 10 | 10 | 10 | |
| TO DAIRY | | | | | | |
| TRANSPORTATION TO DAIRY SUB-TOTAL | | | | 110 | 60 | 0 |
| DAIRY | MEETS | NO | 250 | | | −250 |
| | STANDARDS | | | | | |
| | CONSISTENTLY | | | | | |
| DAIRY | MEETS | YES | 250 | 250 | 250 | |
| | STANDARDS | | | | | |
| | CONSISTENTLY | | | | | |
| DAIRY | PASTEURIZATION | HTST | −250 | | | |
| DAIRY | PASTEURIZATION | UHT | −250 | | −250 | −250 |
| DAIRY | PASTEURIZATION | COLD | −500 | | | |
| DAIRY | PASTEURIZATION | VAT | 500 | 500 | | |
| DAIRY | HOMOGENIZED | NO | 50 | 50 | | |
| DAIRY | HOMOGENIZED | YES | −50 | | −50 | −50 |
| DAIRY SUB-TOTAL | | | | 800 | −50 | −550 |
| TRANSPORTATION | HAUL DISTANCE | SHORT | 50 | 50 | | |
| TO | | | | | | |
| DISTRIBUTION | | | | | | |
| TRANSPORTATION | HAUL DISTANCE | MEDIUM | 0 | | 0 | |
| TO | | | | | | |
| DISTRIBUTION | | | | | | |
| TRANSPORTATION | HAUL DISTANCE | LONG | −50 | | | −50 |
| TO | | | | | | |
| DISTRIBUTION | | | | | | |
| TRANSPORTATION | TRUCK | NO | −50 | | | −50 |
| TO | LOCATION | | | | | |
| DISTRIBUTION | TRACKED | | | | | |
| TRANSPORTATION | TRUCK | YES | 50 | 50 | 50 | |
| TO | LOCATION | | | | | |
| DISTRIBUTION | TRACKED | | | | | |
| TRANSPORTATION | SENSORS | NO | −10 | | | −10 |
| TO | | | | | | |
| DISTRIBUTION | | | | | | |
| TRANSPORTATION | SENSORS | YES | 10 | 10 | 10 | |
| TO | | | | | | |
| DISTRIBUTION | | | | | | |

| | | | |
|---|---|---|---|
| TRANSPORTATION TO DISTRIBUTION SUB-TOTAL | 110 | 60 | −110 |
| TOTAL | 2120 | 920 | −1460 |

Chart 1 is one example of a scoring system for dairy product quality inputs that scores various quality elements, and provides a corresponding color code. As an example, Green = Best, Yellow = Fair, and Red = Worst. Each color code would have an upper and lower numerical limit for determining which color to output to a consumer.

CHART 2
MEAT QUALITY INPUTS

| | | | | BEST | FAIR | WORST |
|---|---|---|---|---|---|---|
| QUALITY | QUALITY | QUALITY | POSSIBLE | SCORE | SCORE | SCORE |
| ITEM 1 | ITEM 2 | ITEM 3 | POINTS | (GREEN) | (YELLOW) | (RED) |
| FARM | SEED SOURCE | MINIMALLY | 50 | 50 | 50 | |
| | | PROCESSED | | | | |
| | | ORGANIC | | | | |
| FARM | SEED SOURCE | HYBRID | −50 | | | −50 |
| FARM | GROUND | AMISH | 500 | 500 | | |
| FARM | GROUND | MENNONITE | 500 | | | |
| FARM | GROUND | MINIMALLY | 250 | | 250 | |
| | | PROCESSED | | | | |
| | | ORGANIC | | | | |
| FARM | GROUND | RECLAIMED | 0 | | | |
| | | SOIL | | | | |
| | | MINIMALLY | | | | |
| | | PROCESSED | | | | |
| | | ORGANIC | | | | |
| FARM | GROUND | INDUSTRIAL | −100 | | | |
| | | MINIMALLY | | | | |
| | | PROCESSED | | | | |
| | | ORGANIC | | | | |
| FARM | GROUND | NON- | −250 | | | −250 |
| | | MINIMALLY | | | | |
| | | PROCESSED | | | | |
| | | ORGANIC | | | | |
| FARM | WATER SOURCE | LOW | −100 | | | −100 |
| | QUALITY | | | | | |
| FARM | WATER SOURCE | MEDIUM | 0 | | | |
| | QUALITY | | | | | |
| FARM | WATER SOURCE | HIGH | 100 | 100 | 100 | |
| | QUALITY | | | | | |
| FARM | ANIMAL | LOW | −50 | | | −50 |
| | GENETICS | | | | | |
| FARM | ANIMAL | MEDIUM | 0 | | | |
| | GENETICS | | | | | |
| FARM | ANIMAL | HIGH | 50 | 50 | 50 | |
| | GENETICS | | | | | |
| FARM | ANIMAL STRESS | LOW | 100 | 100 | 100 | |
| | LEVEL | | | | | |
| FARM | ANIMAL STRESS | MEDIUM | 0 | | | |
| | LEVEL | | | | | |
| FARM | ANIMAL STRESS | HIGH | −100 | | | −100 |
| | LEVEL | | | | | |
| FARM | ANIMAL | NO | 0 | | | 0 |
| | LOCATION | | | | | |
| | TRACKED | | | | | |
| FARM | ANIMAL | YES | 50 | 50 | 50 | |
| | LOCATION | | | | | |
| | TRACKED | | | | | |
| FARM | MEETS | NO | −250 | | | −250 |
| | STANDARDS | | | | | |
| | CONSISTENTLY | | | | | |
| FARM | MEETS | YES | 250 | 250 | 250 | |
| | STANDARDS | | | | | |
| | CONSISTENTLY | | | | | |
| FARM SUB-TOTAL | | | | 1100 | 850 | −800 |
| TRANSPORTATION | HAUL DISTANCE | SHORT | 50 | 50 | | |
| TO PROCESSING | | | | | | |
| PLANT | | | | | | |
| TRANSPORTATION | HAUL DISTANCE | MEDIUM | 0 | | 0 | |
| TO PROCESSING | | | | | | |
| PLANT | | | | | | |
| TRANSPORTATION | HAUL DISTANCE | LONG | −50 | | | |
| TO PROCESSING | | | | | | |
| PLANT | | | | | | |
| TRANSPORTATION | TRUCK | \NO | −50 | | | |
| TO PROCESSING | LOCATION | | | | | |
| PLANT | TRACKED | | | | | |
| TRANSPORTATION | TRUCK | YES | 50 | 50 | 50 | |
| TO PROCESSING | LOCATION | | | | | |
| PLANT | TRACKED | | | | | |
| TRANSPORTATION | SENSORS | NO | −10 | | | |
| TO PROCESSING | | | | | | |
| PLANT | | | | | | |
| TRANSPORTATION | SENSORS | YES | 10 | 10 | 10 | |
| TO PROCESSING | | | | | | |
| PLANT | | | | | | |
| TRANSPORTATION TO PROCESSING PLANT SUB-TOTAL | | | | 110 | 60 | 0 |
| PROCESSING | MEETS | NO | 250 | | | −250 |
| PLANT | STANDARDS | | | | | |
| | CONSISTENTLY | | | | | |
| PROCESSING | MEETS | YES | 250 | 250 | 250 | |
| PLANT | STANDARDS | | | | | |
| | CONSISTENTLY | | | | | |
| PROCESSING PLANT SUB-TOTAL | | | | 800 | −50 | −550 |
| TRANSPORTATION | HAUL DISTANCE | SHORT | 50 | 50 | | |
| TO | | | | | | |
| DISTRIBUTION | | | | | | |
| TRANSPORTATION | HAUL DISTANCE | MEDIUM | 0 | | 0 | |
| TO | | | | | | |
| DISTRIBUTION | | | | | | |
| TRANSPORTATION | HAUL DISTANCE | LONG | −50 | | | −50 |
| TO | | | | | | |
| DISTRIBUTION | | | | | | |
| TRANSPORTATION | TRUCK | NO | −50 | | | −50 |
| TO | LOCATION | | | | | |
| DISTRIBUTION | TRACKED | | | | | |
| TRANSPORTATION | TRUCK | YES | 50 | 50 | 50 | |
| TO | LOCATION | | | | | |
| DISTRIBUTION | TRACKED | | | | | |
| TRANSPORTATION | SENSORS | NO | −10 | | | −10 |
| TO | | | | | | |
| DISTRIBUTION | | | | | | |
| TRANSPORTATION | SENSORS | YES | 10 | 10 | 10 | |
| TO | | | | | | |
| DISTRIBUTION | | | | | | |

| | | | |
|---|---|---|---|
| TRANSPORTATION TO DISTRIBUTION SUB-TOTAL | 110 | 60 | −110 |
| TOTAL | 2120 | 920 | −1460 |

Chart 2 is one example of a scoring system for meat, including, but not limited to, beef, lamb, pork, fowl, fish, etc., product quality inputs that scores various quality elements, and provides a corresponding color code. Green = Best, Yellow = Fair, and Red = Worst. Each color code would have an upper and lower numerical limit for determining which color to output to a consumer.

CHART 3
RAW FRUIT, VEGETABLE, NUT, AND EGG PRODUCT QUALITY INPUTS

| | | | | BEST | FAIR | WORST |
|---|---|---|---|---|---|---|
| QUALITY | QUALITY | QUALITY | POSSIBLE | SCORE | SCORE | SCORE |
| ITEM 1 | ITEM 2 | ITEM 3 | POINTS | (GREEN) | (YELLOW) | (RED) |
| FARM | SEED SOURCE | MINIMALLY | 50 | 50 | 50 | |
| | | PROCESSED | | | | |
| | | ORGANIC | | | | |
| FARM | SEED SOURCE | HYBRID | −50 | | | −50 |
| FARM | GROUND | AMISH | 500 | 500 | | |
| FARM | GROUND | MENNONITE | 500 | | | |
| FARM | GROUND | MINIMALLY | 250 | | 250 | |
| | | PROCESSED | | | | |
| | | ORGANIC | | | | |
| FARM | GROUND | RECLAIMED | 0 | | | |
| | | SOIL | | | | |
| | | MINIMALLY | | | | |
| | | PROCESSED | | | | |
| | | ORGANIC | | | | |
| FARM | GROUND | INDUSTRIAL | −100 | | | |
| | | MINIMALLY | | | | |
| | | PROCESSED | | | | |
| | | ORGANIC | | | | |
| FARM | GROUND | NON- | −250 | | | −250 |
| | | MINIMALLY | | | | |
| | | PROCESSED | | | | |
| | | ORGANIC | | | | |
| FARM | WATER | LOW | −100 | | | −100 |
| | SOURCE | | | | | |
| | QUALITY | | | | | |
| FARM | WATER | MEDIUM | 0 | | | |
| | SOURCE | | | | | |
| | QUALITY | | | | | |
| FARM | WATER | HIGH | 100 | 100 | 100 | |
| | SOURCE | | | | | |
| | QUALITY | | | | | |
| FARM | MEETS | NO | −250 | | | −250 |
| | STANDARDS | | | | | |
| | CONSISTENTLY | | | | | |
| FARM | MEETS | YES | 250 | 250 | 250 | |
| | STANDARDS | | | | | |
| | CONSISTENTLY | | | | | |
| FARM SUB-TOTAL | | | | 900 | 650 | −650 |
| TRANSPORTATION | HAUL | SHORT | 50 | 50 | | |
| TO | DISTANCE | | | | | |
| PROCESSING | | | | | | |
| PLANT | | | | | | |
| TRANSPORTATION | HAUL | MEDIUM | 0 | | 0 | |
| TO | DISTANCE | | | | | |
| PROCESSING | | | | | | |
| PLANT | | | | | | |
| TRANSPORTATION | HAUL | LONG | −50 | | | |
| TO | DISTANCE | | | | | |
| PROCESSING | | | | | | |
| PLANT | | | | | | |
| TRANSPORTATION | TRUCK | NO | −50 | | | |
| TO | LOCATION | | | | | |
| PROCESSING | TRACKED | | | | | |
| PLANT | | | | | | |
| TRANSPORTATION | TRUCK | YES | 50 | 50 | 50 | |
| TO | LOCATION | | | | | |
| PROCESSING | TRACKED | | | | | |
| PLANT | | | | | | |
| TRANSPORTATION | SENSORS | NO | −10 | | | |
| TO | | | | | | |
| PROCESSING | | | | | | |
| PLANT | | | | | | |
| TRANSPORTATION | SENSORS | YES | 10 | 10 | 10 | |
| TO | | | | | | |
| PROCESSING | | | | | | |
| PLANT | | | | | | |
| TRANSPORTATION TO PROCESSING PLANT SUB-TOTAL | | | | 110 | 60 | 0 |
| PROCESSING | MEETS | NO | −250 | | | −250 |
| PLANT | STANDARDS | | | | | |
| | CONSISTENTLY | | | | | |
| PROCESSING | MEETS | YES | 250 | 250 | 250 | |
| PLANT | STANDARDS | | | | | |
| | CONSISTENTLY | | | | | |
| PROCESSING PLANT SUB-TOTAL | | | | 800 | −50 | −550 |
| TRANSPORTATION | HAUL | SHORT | 50 | 50 | | |
| TO | DISTANCE | | | | | |
| DISTRIBUTION | | | | | | |
| TRANSPORTATION | HAUL | MEDIUM | 0 | | 0 | |
| TO | DISTANCE | | | | | |
| DISTRIBUTION | | | | | | |
| TRANSPORTATION | HAUL | LONG | −50 | | | −50 |
| TO | DISTANCE | | | | | |
| DISTRIBUTION | | | | | | |
| TRANSPORTATION | TRUCK | NO | −50 | | | −50 |
| TO | LOCATION | | | | | |
| DISTRIBUTION | TRACKED | | | | | |
| TRANSPORTATION | TRUCK | YES | 50 | 50 | 50 | |
| TO | LOCATION | | | | | |
| DISTRIBUTION | TRACKED | | | | | |
| TRANSPORTATION | SENSORS | NO | −10 | | | −10 |
| TO | | | | | | |
| DISTRIBUTION | | | | | | |
| TRANSPORTATION | SENSORS | YES | 10 | 10 | 10 | |
| TO | | | | | | |
| DISTRIBUTION | | | | | | |

| | | | |
|---|---|---|---|
| TRANSPORTATION TO DISTRIBUTION SUB-TOTAL | 110 | 60 | −110 |
| TOTAL | 1920 | 720 | −1310 |

Chart 3 is one example of a scoring system for agricultural products, such as, but not limited to, fruits, vegetables, nuts, eggs, etc., for quality inputs that scores various quality elements, and provides a corresponding color code. Green = Best, Yellow = Fair, and Red = Worst. Each color code would have an upper and lower numerical limit for determining which color to output to a consumer.

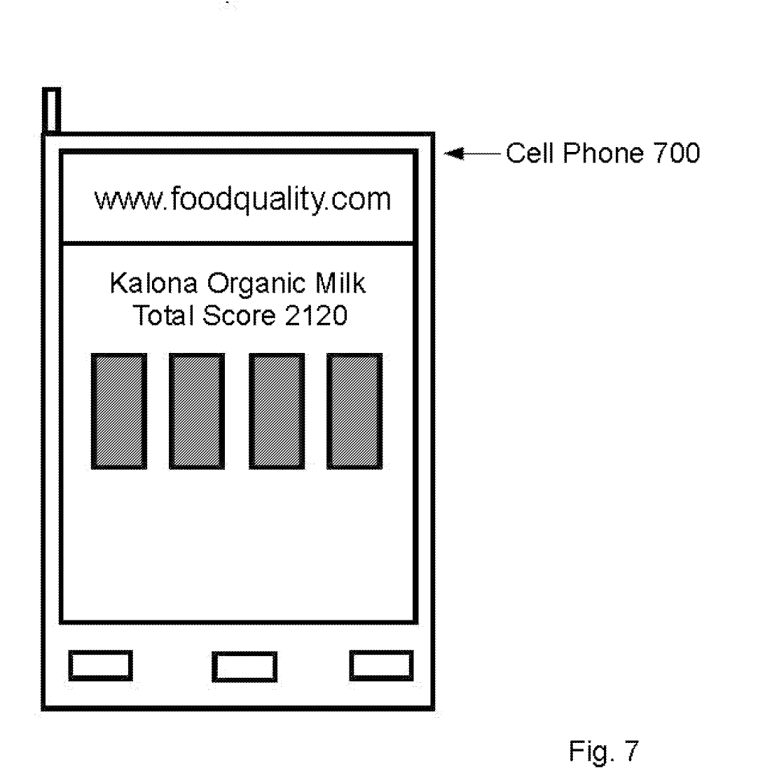

The following is an example of how a consumer might use the present invention to shop for the best quality products in a retail, or wholesale outlet. A consumer could user their wireless device, such as a cell phone or smart phone camera to take a picture of the barcode on a product package. There are applications for wireless phones that will decode a bar code. The consumers' phone would connect wireless to an application provider (foodquality.com, as an example) that would receive the decoded bar code, and return a numeric score, which is also color coded, as illustrated in FIG. 7. The consumer would have a great deal of confidence that they had chosen a milk product of the highest quality. FIG. 7 is an illustration of the present invention's scoring system shown on a cell phone 700 display. In addition to a consumer's phone, other devices are suited for use with the present invention, such as, but not limited to, PC, laptop, iPAD, notebook, netbook, etc.

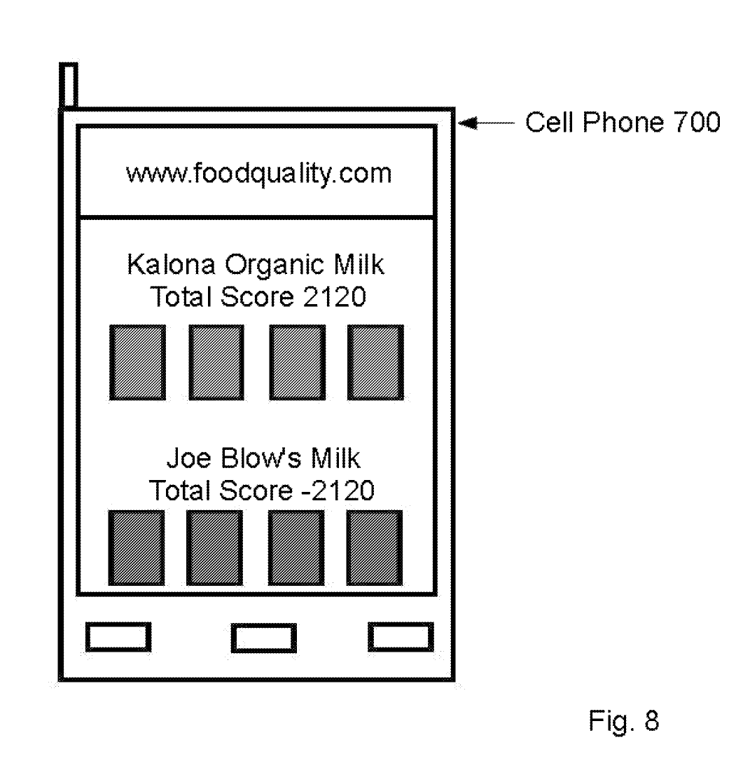

The following is an example of how a consumer might use the present invention to comparison shop for the best quality products in a retail, or wholesale outlet. A consumer could use their wireless device, such as a cell phone or smart phone camera to take a picture of the barcode on at least two product packages. There are applications for wireless phones that will decode a bar code. The consumers' phone would connect wireless to an application provider (foodquality.com, as an example) that would receive the decoded bar codes, and return numeric scores, which are also color coded, as illustrated in FIG. 8. The consumer would have a great deal of confidence that they had chosen a milk product of the highest quality. FIG. 8 is an illustration of the present invention's scoring system shown on a cell phone 700 display. In addition to a consumer's phone, other devices are suited for use with the present invention, such as, but not limited to, PC, laptop, iPAD, notebook, netbook, etc.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention.

Accordingly, while the present invention has been described herein in detail in relation to a particular embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed:

1. A method of providing information to a consumer indicative of relative quality of a food item, the method comprising:
determining the relative quality of the food item using a scoring system which determine a representation of the relative quality of the food item using a numeric score, a color code, and additional quality metrics;
electronically delivering the representation of the relative quality to the device.

2. The method of claim 1 wherein said device is chosen from the set consisting of cell phone, smart phone, iPad, PC, laptop, notebook, and netbook.

3. The method of claim 1 wherein said corresponding color code is selected for the set consisting of green, yellow, and red.

4. The method of claim 3 where said corresponding green color code indicates the highest score range.

5. The method of claim 3 wherein said corresponding yellow color code indicates a middle score range.

6. The method of claim 3 wherein said corresponding red color code indicates the lowest score range.

7. The method of claim 1 wherein a food item is identified by a bar code captured by said device.

8. The method of claim 7 wherein a food item bar code is scanned using a camera in communication with said device.

9. The method of claim 7 wherein a food item bar code is manually keyed into said device.

10. The method of providing information to a consumer regarding the relative quality using of a food item using a scoring system that delivers electronically to a device a numeric score and corresponding color code, and additional quality metrics.

11. The method of claim 10 wherein additional quality metrics are selected from the set consisting of: kosher, and super kosher.

12. The method of providing information to a consumer regarding the relative quality using of a food item using a scoring system that delivers electronically to a device a numeric score and corresponding color code, and additional certifications.

13. The method of claim 12 wherein additional certifications are selected from the set consisting of: green agriculture, certified organic, certified fair trade, micro-economics, and micro-finance.

14. The method of providing vat pasteurized milk, and milk derivative products in the market comprising of: raw milk sourced from Amish farms; vat pasteurized at 145 degrees Fahrenheit for at least 30 minutes.

15. The method of providing vat pasteurized milk, and milk derivative products in the market comprising of: raw milk sourced from Mennonite farms; vat pasteurized at 145 degrees Fahrenheit for at least 30 minutes.

16. The method of claim 14 wherein 1% milk is blended from vat pasteurized skimmed and whole milk.

17. The method of claim 14 wherein 2% milk is blended from vat pasteurized skimmed and whole milk.

18. The method of claim 15 wherein 1% milk is blended from vat pasteurized skimmed and whole milk.

19. The method of claim 15 wherein 2% milk is blended from vat pasteurized skimmed and whole milk.

20. The method of providing vat pasteurized milk, and milk derivative products in the market comprising of: raw milk sourced from certified organic farms; vat pasteurized at 145 degrees Fahrenheit for at least 30 minutes.

21. The method of claim 20 wherein 1% milk is blended from vat pasteurized skimmed and whole milk.

22. The method of claim 20 wherein 2% milk is blended from vat pasteurized skimmed and whole milk.
